(19) United States
(12) Patent Application Publication
(10) Pub. No.: US 2025/0086541 A1
(43) Pub. Date: Mar. 13, 2025

(54) SUPPLY CHAIN DIGITAL TWIN SYSTEM

(71) Applicant: SAUDI ARABIAN OIL COMPANY, Dhahran (SA)

(72) Inventor: Saud Al-Temyatt, Dhahran (SA)

(73) Assignee: SAUDI ARABIAN OIL COMPANY, Dhahran (SA)

(21) Appl. No.: 18/466,279

(22) Filed: Sep. 13, 2023

(51) Int. Cl. G06Q 10/0631; E21B 41/00; G06Q 10/0635; G06Q 10/087; G06Q 30/0601

(52) U.S. Cl. CPC G06Q 10/06312; E21B 41/00; G06Q 10/0635; G06Q 10/087; G06Q 30/0633; G06Q 10/06313; G06Q 10/06315; G06Q 30/0283; G06Q 50/02

(57) ABSTRACT

A digital supply chain twin system includes a transceiver and a processor. The transceiver receives supplier inventory data specifying parts forming products to initiate, maintain, or use a wellbore. The processor executes a drilling operations module, a materials module, a workflow module, and a demand quantity prediction module, which form a supply chain twin platform. The drilling operations module stores scheduling data of wellsite procedures. The materials module stores information specifying parts necessary for the manufacturer to build products, and determines a quantity of products built thereby. The workflow module determines manufacturer inventory information specifying available products, and a moving average representing products built during a predetermined time period. The demand quantity prediction module predicts a forecast quantity of products built prior to the scheduled date. The drilling operations module reschedules the wellsite procedures when the requisite quantity is greater than the forecast quantity of products for the scheduled date.

### BACKGROUND

In order to efficiently mass produce a product for use in an oil and gas related operation, such as a drill bit used to drill a section of a wellbore, the product is assembled or manufactured in a series of stages that form a supply chain. Typically, the supply chain includes entities such as a supplier that delivers raw parts and/or services to a manufacturing facility run by a manufacturer. The manufacturer proceeds to build products and assemblies from the raw parts in order to form a product used during a well operation. The product is then used at the wellsite as part of the oil and gas operation, and may be used directly by the manufacturer, or by a third party consumer, for example. Alternatively, if the mass produced product is a product of the oil and gas operation, such as barrels of oil, the supply chain includes the manufacturer collecting the oil and distributing the barrels of oil to a consumer.

Regardless of the purpose of the supply chain in relation to the oil and gas operation, various logistical challenges can arise as a result of multiple entities of the supply chain interacting. For example, a supplier may be unable to deliver raw goods and parts to the manufacturer, or the manufacturer may not be able to produce a required number of products for a consumer. In such cases, it is necessary to revise the supply chain process as a whole to compensate for any of the aforementioned logistical challenges. Such revisions may include communicating with a supplier to request additional raw goods and parts, or adjusting the start date of a well operation until the required products have been made.

### SUMMARY

A digital supply chain twin system includes a transceiver and a processor. The transceiver receives supplier inventory data including information specifying one or more parts, located at a first supplier, that form one or more products that are used in one or more wellsite procedures by a manufacturer to initiate, maintain, or use a wellbore. The processor executes a series of modules forming a supply chain twin platform, where the series of modules includes a drilling operations module, a materials module, a workflow module, and a demand quantity prediction module. The drilling operations module stores scheduling data that includes a scheduled date of the wellsite procedures. The materials module stores construction information that specifies a requisite number of parts necessary for the manufacturer to build the products, and determines a requisite quantity of the products built by the manufacturer to be used during the wellsite procedures. The workflow module determines manufacturer inventory information specifying an amount of the products that have been built and are available for use by the manufacturer, and a moving average representative of the number of products built during a predetermined time period. The demand quantity prediction module predicts, based on the construction information, the moving average, and the scheduling data, a forecast quantity of the available products built by the manufacturer prior to the scheduled date. The drilling operations module reschedules the wellsite procedures to a later date when the demand quantity prediction module determines that the requisite quantity of products is greater than the forecast quantity of the available products for the scheduled date.

A method for automatically ordering parts for use during one or more wellsite procedures includes receiving supplier inventory data with a transceiver of a digital supply chain twin system. The supplier inventory data includes information specifying one or more parts, located at a first supplier, that form one or more products that are used in the wellsite procedures by a manufacturer to initiate, maintain, or use a wellbore. The method further includes executing, with a processor, a series of modules that form a supply chain twin platform. The execution includes storing, with a drilling operations module of the supply chain twin platform, scheduling data that includes a scheduled date of the wellsite procedures. The method further includes storing, with a materials module of the supply chain twin platform, construction information that specifies a requisite number of parts necessary for the manufacturer to build the products. Subsequently, a workflow module of the supply chain twin platform determines manufacturer inventory information specifying an amount of the products that have been built and are available for use by the manufacturer, and further determines a moving average representative of the number of products built during a predetermined time period. The materials module stores a requisite quantity of the products at the scheduled date based on the construction information and the scheduling data. The demand quantity prediction module determines a forecast quantity of available products built by the manufacturer prior to the scheduled date. Finally, the method includes rescheduling the wellsite procedures to a later date, with the drilling operations module, when the demand quantity prediction module determines that the requisite quantity of products is greater than the forecast quantity of the available products for the scheduled date.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 depicts a block diagram of an industrial environment in accordance with one or more embodiments of the invention.

FIG. 2 depicts a supply chain twin platform in accordance with one or more embodiments of the invention.

FIG. 3 depicts an information flow diagram of a supply chain twin platform in accordance with one or more embodiments of the invention.

FIG. 4 depicts a lookup table used by a supply chain twin platform in accordance with one or more embodiments of the invention.

FIG. 5 depicts a User Interface (UI) of a supply chain twin platform in accordance with one or more embodiments of the invention.

FIG. 6 depicts a wellsite in accordance with one or more embodiments of the invention.

FIG. 7 depicts a flowchart of a method in accordance with one or more embodiments of the present disclosure.

### DETAILED DESCRIPTION

Specific embodiments of the disclosure will now be described in detail with reference to the accompanying figures. In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, one or more embodiments of the invention are directed towards creating a digital supply chain twin system that interlinks a manufacturer of a product to one or more suppliers of raw parts, consumers of the product, and a wellsite procedures schedule. This creates end-to-end transparency across the supply chain by merging key data sets related to demand planning, procurement, inventory, warehousing, and other logistics into a real-time intuitive and accessible platform. The real time view of the supply chain allows cross-functional tracking of Key Performance Indicators (KPIs) to ensure that the process reflected by the supply chain digital twin is completed in a timely, cost-effective, and sustainable manner. The real-time view further enables operators, management personnel, and consumers alike to be informed, via a tailored interface, of the progress of the wellsite procedures.

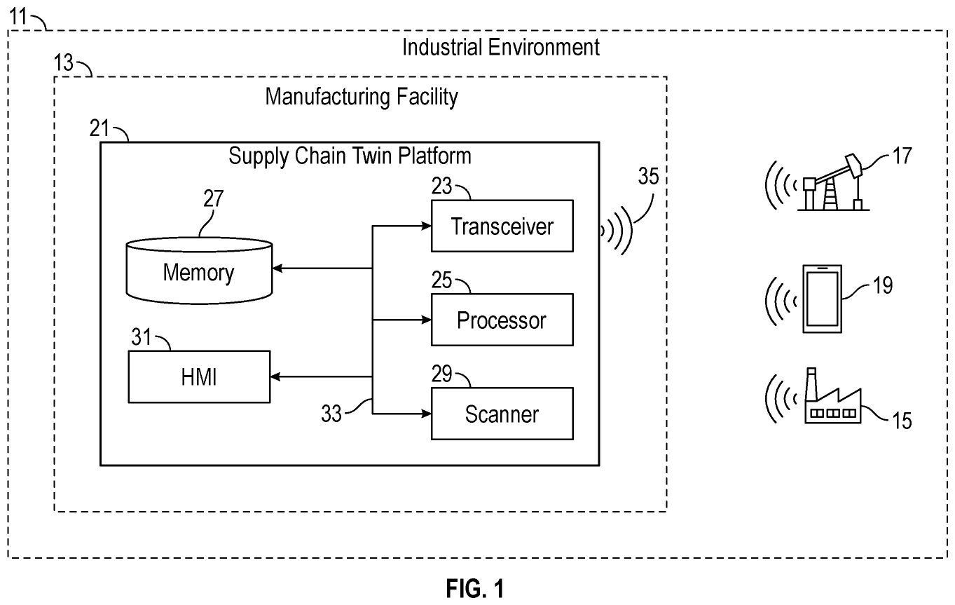

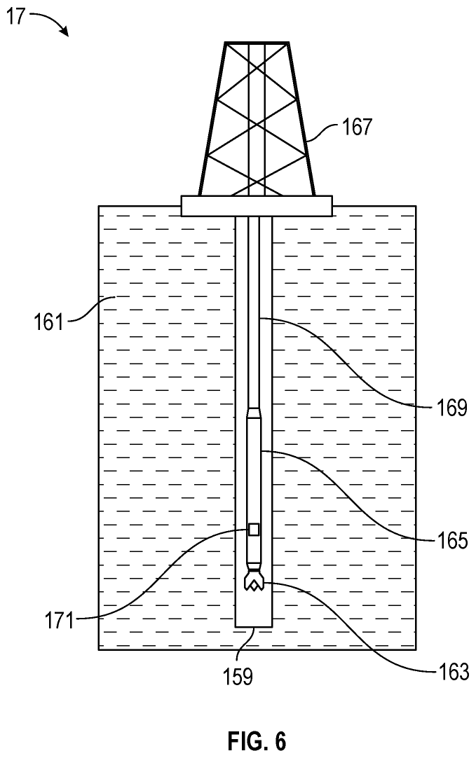

Turning to FIG. 1, FIG. 1 depicts an overview of an industrial environment 11 in accordance with one or more embodiments of the invention as described herein. As shown in FIG. 1, the industrial environment 11 includes a manufacturing facility 13, a supplier facility 15, a wellsite 17, and a mobile device 19. The manufacturing facility 13 is a facility that makes products for one or more wellsite procedures completed at the wellsite 17. The wellsite procedures include, for example, a process of drilling a new or existing wellbore (e.g., FIG. 6), a process for determining petrophysical properties of a subterranean formation surrounding a wellbore, well remediation procedures such as plugging a damaged well (not shown), procedures for acquiring tangible goods (such as fluid reserves) from the wellbore, (not shown) or any other operation performed at the wellsite 17 during the life cycle of the wellbore. Similarly, the wellsite 17 includes a wellbore (e.g., FIG. 6) and systems and assemblies useful for creating and maintaining the wellbore, such as a drilling rig (e.g., FIG. 6) and a mud system (not shown), for example. Accordingly, the products for the one or more wellsite procedures as described herein include, for example, products such as a drill bit used to extend the wellbore (e.g., FIG. 6), a plug (not shown) or Blow Out Preventer (BOP) (not shown) for closing the wellbore, downhole sensors such as a downhole pressure sensor (e.g., FIG. 6) and accelerometers/gyroscopes (not shown), or equivalent devices used in downhole procedures and other wellsite procedures.

The wellsite procedures are completed with the use of a product built, assembled, or otherwise manufactured at the manufacturing facility 13. The product is formed of one or more raw parts and/or materials harvested by a supplier facility 15, which are shipped to the manufacturing facility 13 by way of a semi-truck, freight train, barge, or other postal vehicle. Once the raw parts are received by the manufacturing facility 13, operators of the manufacturing facility 13 proceed to assemble or manufacture the products from the parts via processes such as casting, welding, brazing, adhering, lathing, or equivalent machining and tooling processes.

To facilitate the logistics of manufacturing the product, the manufacturing facility 13 includes a supply chain twin platform 21. As shown in FIG. 1, the supply chain twin platform 21 includes a transceiver 23, a processor 25, a memory 27, a scanner 29, a Human Machine Interface (HMI) 31, and a bus 33. As described herein, the transceiver 23 is formed as one or more Wi-Fi cards, Bluetooth chips, circuits, coils of wire, antennas, or data ports that respectively gather and send radiofrequency signals to and from the manufacturing facility 13, the supplier facility 15, the wellsite 17, and the mobile device 19. In this way, signals transmitted by the transceiver 23 form a wireless data connection with the wellsite 17, the mobile device 19, and the supplier facility 15, which is denoted as the data connection 35 in FIG. 1. Signals are transmitted by the transceiver 23 on frequency bands that have a frequency as low as 400 Megahertz (MHz) and as high as 100 Gigahertz (GHz). The signals received by the transceiver 23 reflect supplier inventory data specifying a number of raw parts, located at the supplier facility 15, that are used in the wellsite procedures. The supplier inventory data may be collected at the supplier facility 15, for example, by determining the amount of parts harvested by the supplier facility 15, or by scanning a Stock Keeping Unit (SKU) of the parts to automatically create the supplier inventory data as described below.

Once received from the transceiver 23, the supplier inventory data is passed to a processor 25 and a memory 27. As described herein, the memory 27 comprises a non-transient storage medium such as Random Access Memory (RAM), a Hard Disk Drive (HDD), a Solid State Drive (SSD), flash memory, or equivalent storage devices. On the other hand, the processor 25 includes one or more processors, microprocessors, logic units, logic gates, controllers, microcontrollers, and/or integrated circuits that receive, process, and transmit information related to the drilling procedures described above. The transceiver 23, the processor 25, and the memory 27 are interconnected by a bus 33 that is formed as one or more wires, Printed Circuit Boards (PCBs), optical fibers, or equivalent structures that serve to transmit electrical signals between the various components of the supply chain twin platform 21.

As described herein, the processor 25 serves to facilitate the logistics of forming one or more products from the parts received from the supplier facility 15. To do this, the processor 25 accesses the supplier inventory information stored on the memory 27, and determines the number of products that can be built by the manufacturer based on the supplier inventory information. The processor 25 further accesses the memory 27 to determine the scheduled date of the wellsite procedures at the wellsite 17, and determines whether the manufacturer is able to build a requisite number of products for the wellsite procedures by the scheduled date. In the event that the manufacturing facility 13 is unable to build the requisite number of products, the supply chain twin platform 21 reschedules the wellsite procedures at the wellsite 17 to a later date when the products are forecast to be built.

Thus, the supply chain twin platform 21 automatically facilitates the process of scheduling and rescheduling wellsite procedures based upon the supplier inventory data. This aids in reducing the cost of the well procedure overall, as the well procedure is not initiated without the products necessary to complete the procedure. The supply chain twin platform 21 further aids in maintaining customer relations between the manufacturing facility 13 and a consumer of the product, as the consumer is apprised of any delays in the process.

Supplier inventory data and scheduling data stored on the memory 27 is visible to the supplier facility 15 and any consumers of the products by way the transceiver 23. For example, a computing device located at the supplier facility 15, or a mobile device 19 that is owned by a consumer, may send a request to view the supplier inventory data and/or scheduled wellsite procedures to the processor 25 of the supply chain twin platform 21 via the transceiver 23. In such cases, the processor 25 confirms that the device is authorized to access the data (e.g., by having the user input a username and password, for example), and presents the data to the user. The data may be presented in the form of a User Interface (UI) embodied as a webpage accessed via the data connection 35, such that the data may be viewed and interacted with remotely. Alternatively, the processor 25 may transmit a dedicated report (such as a Portable Document Format (PDF)) to the user's device via the data connection 35, and the user may view the dedicated report to derive the data therefrom. Due to the data connection 35 interlinking the manufacturing facility 13 to the wellsite 17, mobile device 19, and supplier facility 15, the supply chain twin platform 21 as a whole creates end-to-end transparency between the manufacturing facility 13 and any users directly or indirectly involved in the well procedure.

The information stored on the memory 27 may further be accessed by a Human Machine Interface (HMI) 31 of the supply chain twin platform 21. By way of example, the HMI 31 may be embodied, for example, as a display and associated peripheral components such as a touchscreen, stylus, keyboard, mouse, a combination thereof, or equivalent devices (not shown). Alternatively, the HMI 31 may be embodied as a data port, such as a Universal Serial Bus (USB) port or forms thereof, a thunderbolt port, a storage card port such as a Secure Digital (SD) card port, or equivalent information transmission hubs. The HMI 31 further allows the information stored on the supply chain twin platform 21 to be accessed by an operator located at the manufacturing facility 13, for example.

Finally, the supply chain twin platform 21 includes a scanner 29 that allows SKUs of parts and products to be scanned at the manufacturing facility 13 to determine part and product inventory reserves. Specifically, each part and product used during the well procedure is assigned a Stock Keeping Unit (SKU), which is an alphanumeric string that uniquely identifies the part or product. The SKU is further represented by a barcode adhered to the part or product, where the lines forming the barcode are spaced apart in such a way that the spacing of the lines uniquely corresponds to a particular SKU. Thus, the scanner 29 is formed as a handheld barcode scanner, for example, that emits a laser signal and determines the distance between the lines forming the barcode based upon a laser signal reflected off of the barcode. Once a barcode is scanned, manufacturer inventory information specifying an amount of the products that have been built and are available for use by the manufacturer is updated, as is further discussed below. Thus, as a whole, the supply chain twin platform 21 comprises components used to determine an inventory of raw parts and materials located at a supplier facility 15, as well as an inventory of a number of products that have been built at the manufacturing facility 13 and are available for use in the wellsite procedures.

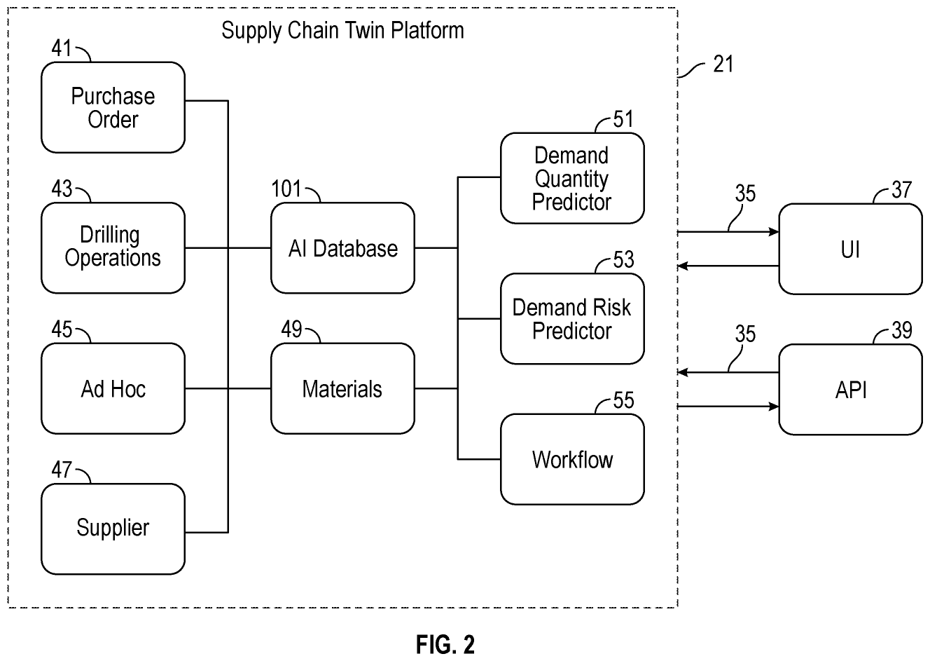

Turning to FIG. 2, FIG. 2 depicts an example of a supply chain platform 21 according to one or more embodiments of the invention described herein. As discussed in relation to FIG. 1, the supply chain twin platform 21 is accessed, by an operator, by way of a data connection 35, which may be embodied as a wired or wireless data transmission link between the supply chain twin platform 21 and a mobile device 19, for example. More specifically, the data connection 35 may be embodied as a Wi-Fi, Bluetooth, Zigbee, Ethernet, Universal Serial Bus (USB) connection, or equivalent data transmission means known to a person of ordinary skill in the art.

The data connection 35 is used to present a User Interface (UI) 37 to an operator, which is a series of text boxes and labels, icons, and graphical data representations that the operator interacts with in order to perform various actions with the supply chain twin platform 21. Such graphical data representations may include, for example, a virtual calendar representing a schedule of the wellsite procedures, various schematic diagrams of parts, products, and materials used in the wellsite procedures, as well as any topographical, petrophysical, and payload data of the wellbore itself. The UI 37 may also be accessed by way of the HMI 31 of the supply chain twin platform 21, which may be embodied as a keyboard, a display (including touchscreen displays), and a mouse as discussed above, for example. In this case, the computer code forming the UI 37 may be installed to the memory 27, and interpreted with the processor 25 which allows the UI 37 to be used locally at the manufacturing facility 13. Furthermore, the processing and interpretation of the UI 37 may be distributed between the supply chain twin platform 21 and a user device, such as the mobile device 19, which is facilitated by the data connection 35.

The supply chain twin platform 21 may also be accessed by the supplier facility 15 by way of an Application Programming Interface (API) 39. Similar to the UI 37, the API 39 is connected to the supply chain twin platform 21 by way of a data connection 35, and may be installed and/or hosted on the computing components (e.g., processor, memory, etc.) of the manufacturing facility 13, the supplier facility 15, or both. As is commonly known in the art, an API is a series of one or more processes, instructions, protocols, and/or rules that allow software hosted in a first environment (such as the supply chain twin platform 21 of the manufacturing facility 13) to communicate with software hosted in a second environment (such as inventory software owned by the supplier facility 15). The API 39 may further define communication requirements for the supplier facility 15, such as a secure connection requirement or a signal strength requirement, and may also place limitations on the amount of traffic processed by the data connection 35, for example. In this way, the API 39 provides an interface for the supplier facility 15 to submit supplier inventory data securely and quickly to the processor 25 and the memory 27 of the manufacturing facility 13 by way of the data connection 35, the transceiver 23, and the bus 33, and one or more computing devices belonging the supplier facility 15 as described above.

FIG. 2 further depicts the software portion of the supply chain twin platform 21, which is formed by a series of modules executed by the processor 25 to perform various operations related to inventory management and scheduled wellsite procedures. More specifically, the modules include a purchase order module 41, a drilling operations module 43, an Ad-Hoc module 45, a supplier module 47, a materials module 49, a demand quantity prediction module 51, a demand risk prediction module 53, a workflow module 55, and an AI database 101. The function(s) of the various modules is further discussed below. Each of the modules are formed as a series of code including algorithms, instructions, and/or operations that may be written in various languages such as Python, C++, C#, R, Java, JavaScript, and equivalent languages known to a person of ordinary skill in the art.

The purchase order module 41 manages incoming and outgoing Purchase Orders (PO) for the manufacturing facility 13. The purchase order module 41 also serves to record data on how many of the requested POs have been fulfilled and the dates of fulfillment, as well as estimated fulfillment dates for currently-unfulfilled POs. As is commonly known in the art, purchase orders include a request for a number of parts to be sent from the supplier facility 15 to the manufacturing facility 13, or a request for the manufacturing facility 13 to ship products to a third part as part of a monetary interaction. In addition, the purchase order module 41 also stores invoices associated with completed purchase orders, which aids in managing budgeting and accounting wellbore procedure-related logistics. In the event that any of the products are returned to the manufacturing facility 13 after a PO is completed, the purchase order module 41 edits the PO data to reflect the updated inventory of products. This allows the supply chain twin platform 21 to be informed on the inventory logistics related to the wellsite procedures as a whole, which in turn allows the supply chain twin platform 21 to report on or revise any wellsite procedures as further discussed below.

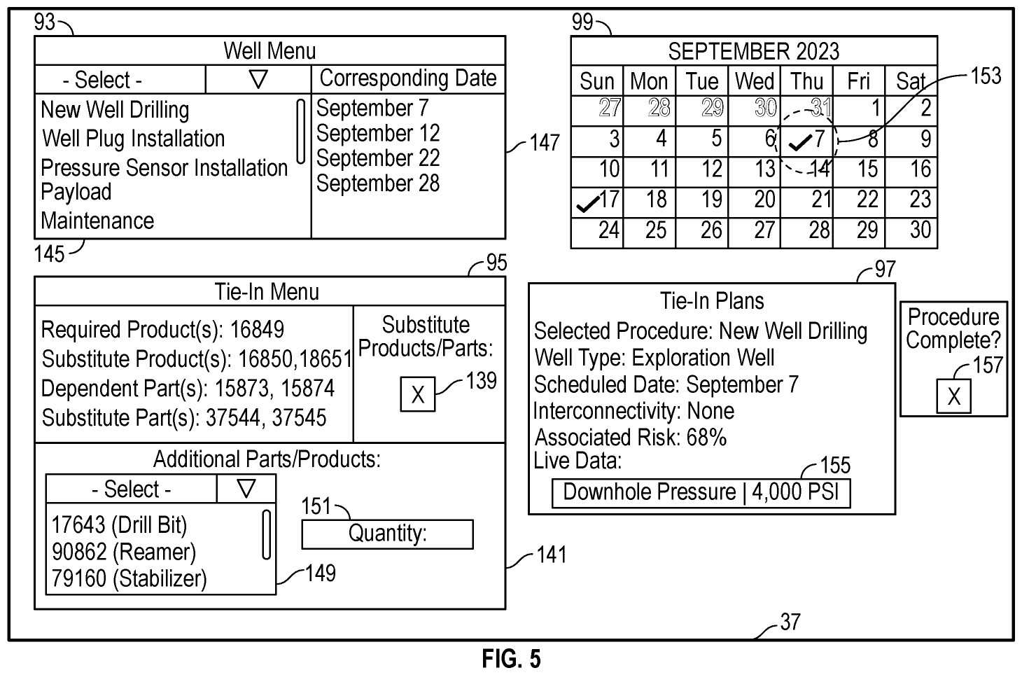

The drilling operations module 43 stores scheduling data for the various wellsite procedures described herein. The scheduling data includes, for example, a scheduled date of the wellsite procedures and a requisite quantity of the products built by the manufacturer to be used during the wellsite procedures. Scheduling data is provided to the operator and stored on the memory 27 in the form of well menus, tie-in plans, and tie-in menus, as discussed below and further discussed in relation to FIG. 5. The well menus include each type of drilling operation that can be performed during the wellsite procedures, and are presented to the user as a drop-down menu, hamburger menu, or equivalent graphic format in the UI 37. The well menus further include a menu of dates at which the well procedure may be completed, which are determined as a function of the availability of the products and an availability of well operators.

Similarly, the tie-in plans are information presented to the operator, as a text box, depicting types and locations of wells that are scheduled to be dilled over the coming years, as well as any connections to existing wells (e.g., tunnels between wellbores, if a particular wellbore is sharing a wellsite with other wellbores, common structures shared between wellbores, etc.). The tie-in menus, on the other hand, include selection menus (such as a drop-down or hamburger menu, or drag-and-drop list) where an operator can add to or edit a bill of materials that includes parts, products, devices, tools, etc. for use in a well procedure, and can select various operations to be completed during the well procedure.

For illustrative and exemplary purposes only, in a case where a well procedure involves drilling a series of wellbores, the scheduling data includes a date or series of dates at which the wellbores are to be drilled, which is selected with the well menu, as well as an estimated number of drill bits (i.e., the requisite quantity of products) necessary to drill the wellbores. As a second example, the supply chain twin platform 21 may be used for a well abandonment procedure, where the requisite quantity of products includes a number of downhole devices, such as a cement plug and associated plugging components, selected with the tie-in menu, and the scheduled date is the date at which a wellbore is to be sealed with the cement plug selected with the well menu.

The drilling operations module 43 is also configured to edit the scheduling data based on inventory management data related to the wellsite procedures. For example, and as described below, the drilling operations module 43 receives a forecast quantity of products that are available for use at the scheduled date, and further compares the forecast quantity of available products to the estimated number of requisite products. In cases where the number of requisite products is greater than the forecast quantity of available products, the drilling operations module 43 reschedules the wellsite procedures to a later date when the forecast quantity eclipses the requisite number of products. In this way, the drilling operations module 43 automatically manages the process for scheduling a well procedure by ensuring that the well procedure is scheduled to a date at which the requisite quantity of products is available to the manufacturing facility 13.

The drilling operations module 43 is further configured to receive real-time information from an operator of the wellsite 17 by way of the data connection 35 and UI 37. For example, during a wellsite procedure the operator accesses the UI 37 by way of a mobile device 19, and selects icons representing the completion of various wellsite processes and procedures. Alternatively, the drilling operations module 43 may receive data directly from a tool or product used in the wellsite procedure. For example, the drilling operations module 43 may be connected to a downhole pressure sensor of a drill string at the wellsite 17 (e.g., FIG. 6), and may determine that the wellsite procedure has been complete once the drill string reaches a certain drilling depth that corresponds to a particular downhole pressure. Thus, the drilling operations module 43 is configured to monitor the real-time progress of the wellsite procedure, which allows the supply chain twin platform 21 as a whole to revise other wellsite procedures instantaneously in the event of impediments to an in-progress wellsite procedure.

The Ad-Hoc module 45 allows guest users limited access to inventory data stored by the supply chain twin platform 21. As noted above, operators and/or suppliers access the inventory data by inputting a username and password into the UI 37 and/or API 39, or a similar user verification process such as dual-factor authentication, security keys, or via security cards emitting a radio-frequency unique to a specific user. However, cases may exist where the manufacturing facility 13 desires to temporarily allow access to the supply chain twin platform 21 to a limited number of users. For example, a systems engineer may wish to present PO and inventory data to a well operator, or a manufacturing facility 13 may wish to share its scheduling data with regulatory authorities such as a local government for legal purposes. In such cases, the Ad-Hoc module 45 provides a simple, configurable user interface that allows the supply chain twin platform 21 to share limited amounts of information with the third-party user.

To enable the above functionality, the Ad-Hoc module 45 presents a dedicated UI to the third-party user, with limited access to specific modules deemed necessary by the manufacturing facility 13 or other responsible authority. The dedicated UI may be displayed to an external device such as the mobile device 19, or a local device such as the HMI 31, for example. As an optional feature, the Ad-Hoc module 45 may be preconfigured with various user profiles that are limited to different modules of the supply chain twin platform 21. For example, the Ad-Hoc module 45 may be configured with a “financial” profile that has access restricted to only the data processed by the purchase order module 41, or a “scheduling” profile that has access restricted to only the data processed by the drilling operations module 43. The Ad-Hoc module 45 may further give the profiles varying levels of read and write access, such that a first, unsecured profile may only “read” (i.e., not edit) data, and a second profile, that is securely protected, may “write” (i.e., edit) data of the various modules. In this way, the Ad-Hoc module 45 allows third party users to easily access and view all data processed by the supply chain twin platform 21 according to the discretion of the manufacturing facility 13.

Continuing with FIG. 2, while the API 39 is used to transmit supplier inventory data from the supplier facility 15 to the manufacturing facility 13 and supply chain twin platform 21, the supplier module 47 provides a supplier facility 15 with dedicated access to the data of the supply chain twin platform 21. Similar to the Ad-Hoc module 45, the supplier module 47 may limit the ability of the supplier facility 15 to access various modules of the supply chain twin platform 21 to prevent a supplier facility 15 from accessing data that the manufacturing facility 13 wishes to keep secret. For example, if the supplier facility 15 is a competitor of the manufacturing facility 13, the manufacturing facility 13 may wish to keep PO data provided by the purchase order module 41 secret from the supplier facility 15 in order to avoid the supplier facility 15 from gaining a competitive advantage. The supplier module 47 is embodied, accordingly, as a dedicated interface that is presented to personnel of the supplier facility 15.

The supplier module 47 also provides communication features for the manufacturing facility 13 and the supplier facility 15. Such communication features include, for example, a chat service that allows suppliers to contact the manufacturer and vice versa, and online forms (such as POs) that the supplier and manufacturer can use to request/fulfil part orders. Further examples of communication features include automatic label generators that generate shipping labels for part to be shipped to a supplier facility 15, as well as return label generators. As an additional example, the dedicated interface generated by the supplier module 47 may include an automatically updated list of POs that a supplier is supposed to fulfil, and information (such as lead times) concerning previously fulfilled POs. As a result, the supplier module 47 eases the logistics of sending parts from a supplier facility 15 to a manufacturing facility 13, and further facilitates communication therebetween.

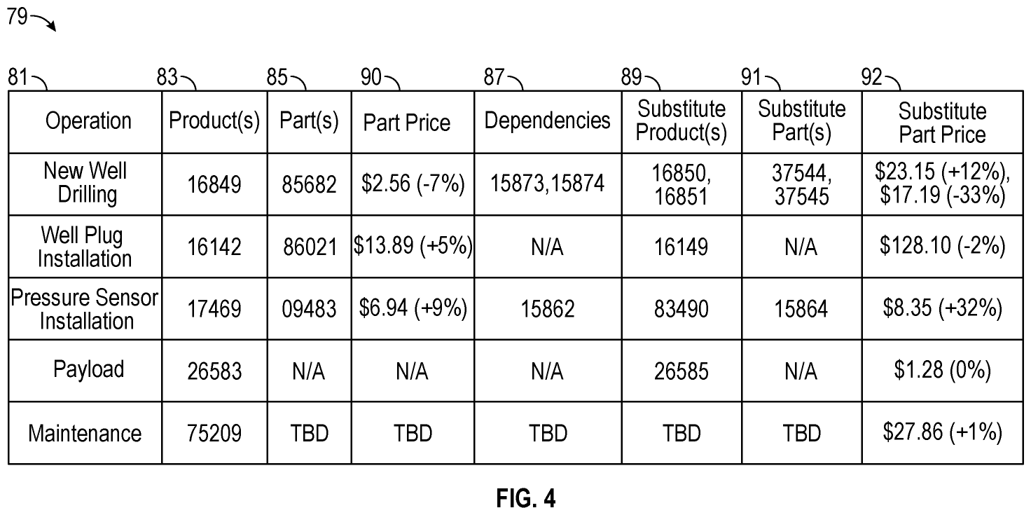

The materials module 49 stores construction information that specifies a requisite number of parts, supplied by a supplier facility 13, that are necessary for the manufacturing facility 13 to build products for the wellsite procedures. Once a particular wellsite procedure is selected, the drilling operations module 43 accesses the materials module 49, which returns a number of products required to complete the wellsite procedure, as well as any parts needed to build or assemble the product. The data specifying the requisite parts and products used in wellsite procedures is stored as a lookup table (e.g., FIG. 4) on the memory 27 such that the materials module 49 performs a lookup function on the data to determine the products and parts associated with the selected wellsite procedure. The data further includes any dependency information of parts that must be used together, such as if a first part or product requires the use of a second part or product to complete a wellsite procedure or form a product. The requisite products and any parts used to build the products are then presented to the user in the bill of materials output by the drilling operations module 43, and used to forecast an available quantity of products as further discussed below.

In addition to storing information regarding the requisite parts used by the manufacturing facility 13 to build a particular product, the materials module 49 further stores substitute data specifying part interchangeability as part of the construction information. Specifically, the substitute data specifies components from a second supplier, or additional parts from the supplier facility 15, that are interchangeable with the requisite parts. In the event that the requisite parts required to build a product are unavailable, the materials module 49 may return the substitute data to the drilling operations module 43, and flag the output such that the operator is aware that the well procedure may need to be completed with substitute parts. In this way, the materials module 49 is able to work in tandem with the drilling operations module 43 to ensure that a well procedure is completed in a timely fashion with products formed of the substitute parts. In the event that a user of the supply chain twin platform 21 does not desire to use the substitute data, the drilling operations module 43 provides an option to disable the substitute data in the tie-in menu, which prevents the materials module 49 from returning or using the substitute data.

The materials module 49 is further configured to store cost information of all parts and products in the lookup table (e.g., FIG. 4). The cost information includes the current cost of a part or product, as well as a historical price thereof and a percentage change of the cost as a function of its historical price. This allows the bill of materials output by the drilling operations module 43 to include pricing information for the entire well procedure. In turn, the cost information may, for example, be used by the operator to ensure that a particular well procedure is within budgeting constraints imposed by a managing entity of the manufacturing facility 13. Furthermore, the cost information allows the materials module 49 to perform spend optimization functions by comparing the cost of the requisite parts to the cost of the substitute parts. In the event that the substitute parts have a lower cost than the requisite parts, the materials module 49 outputs the substitute parts, with a user alert flag reflecting the substitution, to the drilling operations module 43. In this way, the date and cost of wellsite procedures scheduled with the drilling operations module 43 are automatically optimized to the specific desires of a user.

Existing inventory information is captured for the supply chain twin platform 21 by way of the workflow module 55. In particular, the workflow module 55 receives information via the transceiver 23 concerning the supplier inventory data specifying the parts used in the wellsite procedures from the supplier facility 15. In addition, the workflow module 55 stores (in the AI database 101 described below) the amount of resources available to form the products at the manufacturing facility 13, which may include data such as the amount and schedule of the collective manual labor hours operators are expected to complete at the manufacturing facility 13, for example. The workflow module 55 also stores granular data related to each step of a procedure for assembling products at the manufacturing facility 13, as well as the estimated time to complete the assembly, such that the workflow module 55 includes data related to the assembly status of each product at the manufacturing facility 13.

The workflow module 55 also interfaces with the one or more scanners 29 in the manufacturing facility 13, which are used to scan SKUs of the products as they are built and the parts as they are received. The inventory data captured by the workflow module 55 is transmitted to the materials module 49, which updates the AI database 101 to specify the available inventory. The workflow module 55 is also configured to store time-series data specifying when the products are created and the parts are received.

As the inventory data changes, the workflow module 55 computes a series of moving averages of a number of products that have been built within a predetermined time period. Such data representing the moving average of the number of products may be referred to as “moving average data” herein. As is commonly known in the art, a moving average reflects the average value of a measured quantity over a predetermined period of time. Thus, to create the moving average, the workflow module 55 computes an average of a series of timestamped data points of the time-series data. The workflow module 55 proceeds to repeat this process for multiple series of the timestamped data points, and coalesces the data to form time-series data that reflects the moving average of the amount of products built by the manufacturer facility 13 across the entire time period of the timestamped data. Based on the moving average data, the workflow module 55 determines the rate, or lead time, at which products are built, which is used to forecast the number of available products for a wellsite procedure as further discussed below.

To facilitate forecasting of the future availability of parts and products, the supply chain twin platform 21 includes a demand quantity prediction module 51. The demand quantity prediction module 51 may be embodied, for example, as an Artificial Intelligence (AI) model that uses algorithms such as boosted trees, logical regression, or random trees to develop a forecast quantity of products available for the wellsite procedure. The algorithms enable the AI to learn about and form relationships between the data captured with the various modules described above. In particular, based upon the construction information captured by the materials module 49, the moving average data determined by the workflow module 55, and the scheduling data gathered by the drilling operations module 43, the demand quantity prediction module 51 determines previous lead times required for a supplier to fulfill a PO. Based upon the length of time to fulfill the PO (i.e., the lead time), as well as the remaining time prior to the scheduled wellsite procedure, the demand quantity prediction module 51 determines if the products are being built at an acceptable rate. For exemplary purposes, the acceptable rate is a lead time such that a requisite number of products are forecast to be built by the manufacturing facility 13 and are available for use prior to the scheduled date of the wellsite procedure(s). The above described forecast quantity of available products is transmitted to the drilling operations module 43, which may reschedule the wellsite procedures based thereon as described above.

However, the process of forecasting a quantity of available products for the wellsite procedures is necessarily dependent upon a margin of error and a measure of risk assumed by the manufacturing facility 13. For example, a supplier facility 15 may be unable to fulfill one or more POs due to a natural disaster, or the manufacturing facility 13 may experience downtime due to unexpected repairs. To reflect this inherent risk, the supply chain twin platform 21 further includes a demand risk prediction module 53 that determines the risk associated with a particular wellsite procedure. Similar to the demand quantity prediction module 51, the demand risk prediction module 53 is an AI model that uses algorithms such as boosted trees, logical regression, random trees, or equivalent learning models known to a person of ordinary skill in the art.

The risk prediction is determined by the demand risk prediction module 53 as a function of the previous POs stored by the purchase order module 41, inventory information supplied by the workflow module 55, and scheduling data provided by the drilling operations module 43. The demand risk prediction module 53 predicts the risk by assigning weights to each of the aforementioned data, based upon the inherent level of risk associated with the type of data, and forming relationships between the weighted data with the aforementioned algorithms. For example, the demand risk prediction module 53 may determine that multiple wellsite procedures are scheduled within a relatively short time period, and assign a relatively high weight to the scheduling data as a result. On the other hand, if the demand risk prediction module 53 receives inventory data indicating that a large number of products are currently available for use, the demand risk prediction module 53 assigns a relatively low weight as a result. Based upon a relationship formed between the various determined weights (e.g., the relationship formed with the algorithms described above) which range from 0-1, the demand risk prediction module 53 determines an overall level of risk for each particular wellsite procedure. The determined weights and the overall level of risk as described herein range from 0-1, and may be expressed as a whole or decimal number.

The level of risk is further output to the operator by way of the tie-in plan presented by the drilling operations module 43 on the UI 37, which allows the operator to manually determine if a wellsite procedure has a high likelihood of not being completed. Furthermore, if the demand risk prediction module 53 determines that a wellsite procedure has an overall level of risk above a predetermined amount, the demand risk prediction module 53 directs the drilling operations module 43 to reschedule the wellsite procedure to a later date. The predetermined amount of risk may be determined by a manufacturer of the supply chain twin platform 21, by the manufacturing facility 13, or any other entity with the aforementioned credentials required to edit data of the supply chain twin platform 21.

To store and determine values with the Artificial Intelligence (AI) algorithms described herein, which are computed with the demand quantity prediction module 51 and the demand risk prediction module 53 as described above, the supply chain twin platform 21 further includes an AI database 101. The AI database 101 is connected to each of the other various modules of the supply chain twin platform 21, such that the drilling operations module 43 and materials module 49 may input inventory data and/or PO data into the AI database 101 that is subsequently used by the demand quantity prediction module 51 and the demand risk prediction module 53 as described above. As discussed below, one example of an AI database 101 is depicted as Table 1, which stores the information received and determined by the supply chain twin platform 21 in relation to the contemplated wellsite procedure.

Thus, overall, the series of modules that forms the supply chain twin platform 21 allow a wellsite procedure to be automatically scheduled at an optimal time according to the inherent risk and logistical requirements for attempting a wellsite procedure. The series of modules forming the supply chain twin platform 21 further facilitate visibility into the entire supply chain of the wellsite procedure by allowing authorized personnel a transparent view of the real-time logistics and risks associated with the wellsite procedure by way of the user interface 37. Advantageously, this allows a wellsite procedure to be completed in a low-cost and timely manner by ensuring that all parties associated with the wellsite procedure are apprised of the requirements thereof. Furthermore, the supply chain twin platform 21 advantageously ensures that the wellsite procedure is automatically scheduled to be performed at the best time for all parties involved, which reduces the likelihood that a wellsite procedure will not be completed.

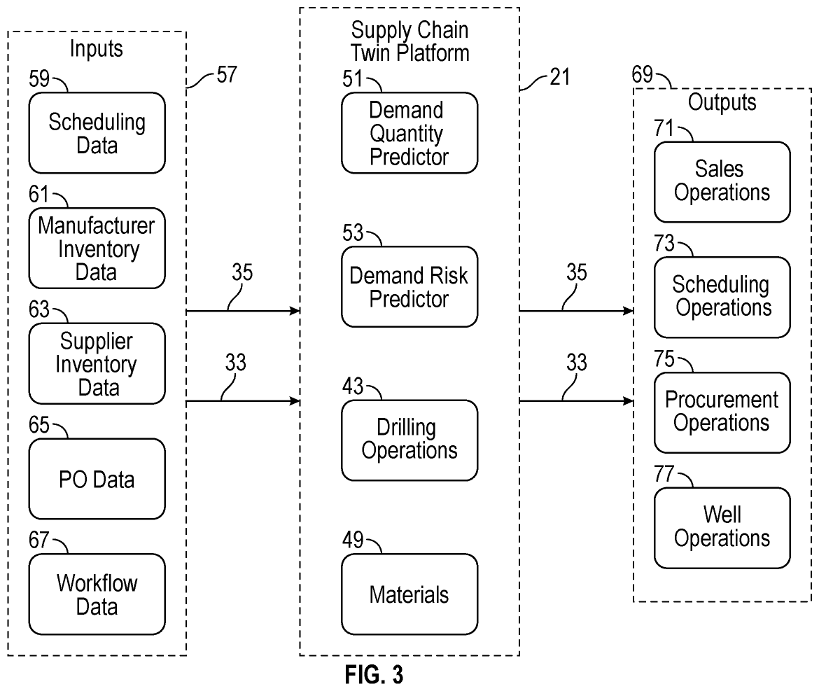

Turning to FIG. 3, FIG. 3 depicts an information flow diagram consistent with one or more embodiments of the invention as described herein. Specifically, FIG. 3 depicts a series of inputs 57 and outputs 69 of the supply chain twin platform 21. The inputs 57 include various forms of data as described above, such as manufacturer inventory data 61, Purchase Order (PO) data 65, workflow data 67, supplier inventory data 63, and scheduling data 59. The manufacturer inventory data 61 and the supplier inventory data 63 are generated by scanning barcodes of Stock Keeping Units (SKUs) of various products and parts created or assembled by the manufacturing facility 13 and supplier facility 15, respectively. The scanning process may be facilitated with a scanner 29 located at one or both of the manufacturing facility 13 and the supplier facility 15, for example. On the other hand, the PO data 65 reflects historical and current quantities of the parts and/or products purchased by the manufacturing facility 13, the supplier facility 15, or a third party, which is input into the supply chain twin platform 21 by way of the various modules described above.

Similarly, the workflow data 67 details the day-to-day inflow and outflow of parts and products from the manufacturing facility 13, and further reflects a number of products that are currently being built or assembled by operators located at the manufacturing facility 13. The scheduling data 59 includes a scheduled date for a particular wellsite procedure or series of wellsite procedures. The scheduling data 59 further includes map data detailing available and scheduled locations of wellsite procedures, which are used to determine if additional wells may be drilled at the wellsite 17 in the event of a well failure, such as a dry well that does not produce a payload of fluids. In this way, the supply chain twin platform 21 is provided with multiple sources of data as its inputs 57 that are used to ultimately determine if a wellsite procedure may be completed in a timely manner.

Once captured, inputs 57 are transmitted to the supply chain twin platform 21 by way of the data connection 35 and/or the bus 33 as described above. More specifically, data (e.g., workflow data 67) captured at the manufacturing facility 13 is directly transferred to the supply chain twin platform 21 by way of the bus 33. On the other hand, data captured by the supplier facility 15, such as the supplier inventory data 63, is transferred to the supply chain twin platform 21 by way of the bus 33 and the transceiver 23 as described above.

As discussed previously in relation to FIG. 2, the supply chain twin platform 21 includes a series of modules that serve to process the inputs 57. Although not all of the modules have been depicted in FIG. 3 for clarity purposes, FIG. 3 depicts that the supply chain twin platform 21 includes a demand quantity prediction module 51, a demand risk prediction module 53, a drilling operations module 43, and a materials module 49 that generate the outputs 69 described in relation to FIG. 3.

In particular, the drilling operations module 43 and the materials module 49 serve to collectively process the inputs 57 to determine the requisite products needed from the manufacturing facility 13 to complete a wellsite procedure. As noted above, an operator selects a particular wellsite procedure and date for the procedure to be completed via the well menu of the drilling operations module 43. Based upon a selected wellsite procedure, the materials module 49 access a lookup table stored on the memory 27 and returns the bill of materials for the selected wellsite procedure to the drilling operations module 43. This allows the drilling operations module 43 to store the bill of materials with the selected wellsite procedure, which allows the remaining modules to determine whether the wellsite procedure may be completed in a timely manner.

The demand quantity prediction module 51 retrieves the bill of materials needed for the wellsite procedure and forecasts an amount of requisite parts and products that will be available for the wellsite procedure. Specifically, the demand quantity prediction module 51 uses algorithms, such as a boosted trees algorithm or logical regression model, to form relationships between the PO data 65 and the bill of materials provided by the drilling operations module 43. Based upon a number of POs that have previously been fulfilled, as well as the time required for the manufacturing facility 13 and/or supplier facility 15, to fulfill the POs, the demand quantity prediction module 51 determines whether an average part or product production rate is sufficient such that the requisite parts/products will be available for the wellsite procedure. For example, in a case where a manufacturing facility 13 builds check valves used in a downhole environment using parts formed by a supplier facility 15, the demand quantity prediction module 51 determines, based on PO data related to the check valves, whether the number of check valves supplied by the materials module 49 for the procedure will be received by the manufacturing facility 13 prior to a scheduled date for installing the check valves at one or more wellbore(s).

Similar to the demand quantity prediction module 51, the demand risk prediction module 53 predicts the risk associated with attempting to complete the wellsite procedure at the scheduled date. To do so, the algorithms used by the demand risk prediction module 53 form relationships between the various inputs 57 and their related impact on the wellsite procedure. The algorithms used by the demand risk prediction module 53 may be the same as those used by the demand quantity prediction module 51, or different algorithms known to a person of ordinary skill in the art.

Although the demand risk prediction module 53 may form any number of different relationships between the inputs 57 and the outputs 69, the primary relationships formed by the demand risk prediction module 53 are time-series relationships between the inputs 57. More specifically, these relationships relate product inventory of the manufacturing facility 13 to the scheduled date of the wellsite procedure. The relationships may be formed, for example, by assigning a weight (e.g., a decimal number between 0-1, inclusive) that is associated with the likelihood that a manufacturing facility 13 or a supplier facility 15 is unable to fulfill a PO, or similar logistic problems are encountered. A low weight (e.g., 0) is assigned to actions that are unlikely to be completed, while a high weight (e.g., 1) is assigned to actions that have a high likelihood of success. Once each of the various relationships are assigned a weight, the demand risk prediction module 53 assigns an overall risk weight to the wellsite procedure. The overall risk weight may be formed, for example, by summing or multiplying the individual weights of the various relationships. As discussed below, the overall risk weight is further used in conjunction with the other data processed by the remaining modules to determine the outputs 69. Furthermore, the process used by the demand risk prediction module 53 to determine the risk weights is further discussed in relation to FIG. 4, below.

In relation to the wellsite 17 as a whole, the outputs 69 represent actions that are taken by the supply chain twin platform 21 to complete the wellsite procedures. As depicted in FIG. 3, the outputs 69 includes actions such as sales operations 71, scheduling operations 73, procurement operations 75, and well operations 77. As described below, the actions may be performed with the data connection 35 if the actions involve transmitting data or operating instructions externally from the manufacturing facility 13. Alternatively, the actions may be performed using the bus 33 if the operations involved transmitting data and/or operating instructions locally at the manufacturing facility 13.

As described herein, sales operations 71 refer to operations taken by the supply chain twin platform 21 related to monetary transactions. Accordingly, the sales operations 71 includes operations related to PO requests and fulfilment, as well as inventory management. For example, and as described above, the manufacturing facility 13 may possess reserves of products to be used in the wellsite procedure, and the supply chain twin platform 21 may determine that a number of operations to be completed within a specific time period (e.g., a number of months) has a high-likelihood of success via the demand risk prediction module 53. In such cases, the purchase order module 41 determines that no new purchase orders are necessary, and restricts the supply chain twin platform 21 from transmitting new purchase orders to require the use of the reserve inventory. As a second example in which the manufacturing facility 13 possess large product inventory reserves, the workflow module 55 may reduce the assigned hours of the operators based upon a forecast amount of assembled products, which lengthens the assembly time while reducing the daily manufacturing facility 13 overhead. In this way, the supply chain twin platform 21 is configured to perform sales operations 71 that offset the expense of operating the manufacturing facility 13.

Similar to the sales operations 71, the scheduling operations 73 relate to actions taken by the supply chain twin platform 21 in relation to a timeline for completing a wellsite procedure. That is, the scheduling operations 73 includes operations such as delaying, canceling, adding, or modifying contemplated wellsite procedures according to the logistics thereof. For example, in a case where a manufacturing facility 13 has low product inventory reserves and a number of wellsite procedures are scheduled to be completed within a relatively short period of time, the scheduling operations 73 include rescheduling one or more of the wellsite procedures to a later date with the drilling operations module 43. The drilling operations module 43 may determine that a particular wellsite procedure needs to be rescheduled based upon its overall risk weight being above a predetermined weight, or if a forecast quantity of available products is less than a requisite number of products needed to complete the wellsite procedure, for example. As a second example, the supply chain twin platform 21 may increase a number of tasks or manual labor hours assigned to one or more operators of the manufacturing facility 13 with the workflow module 55, in order to increase the amount of available products for the wellsite procedure.

Procurement operations 75 related to procuring additional parts from a supplier facility 15 may also be performed as an output 69. Such an operation may be required, for example, if a demand quantity prediction module 51 determines that the forecast quantity of available products is below the requisite number of products. In this case, the procurement operations 75 involves drafting and submitting a purchase order to the supplier facility 15 requesting additional parts to allow the manufacturer facility 13 to build more products prior to the wellsite procedure. As noted above, the PO may be filled out and submitted to the supplier facility 15 by use of the purchase order module 41 depicted in FIG. 2. Alternatively, procurement operations 75 may include determining if substitute parts produced by a second supplier are available, with the materials module 49, and submitting a purchase order to the second supplier requesting the substitute parts.

On the other hand, well operations 77 relate to actions performed in relation to managing the real-world functioning of the wellsite 17. Such actions may include, for example, managing the location and process of drilling the wellbore itself, operating various devices (e.g., valves, a fluid delivery system, a drill string, sensors, etc.) of the wellsite 17, and alerting an operator of required wellsite 17 maintenance. As one example of well operations 77, a case may arise where a drill bit (e.g., FIG. 6) breaks at the wellsite 17, and the wellsite procedure cannot be completed at the present time. In this case, an operator at the wellsite 17 accesses the supply chain twin platform 21, and indicates via the well menu of the drilling operations module 43 that the wellsite procedure must be rescheduled (e.g., by selecting an icon on the UI 37 that corresponds to the wellsite procedure being incomplete as depicted in FIG. 5). In response, the drilling operations module 43 determines a new date and process for drilling a wellbore (using the scheduling data 59), and modifies the schedule of the wellsite procedures to include the new procedure. The determined new date for the wellsite procedure may be further influenced by the inherent risk and forecast quantity of available products as described above.

Accordingly, overall, the outputs 69 of the supply chain twin platform 21 reflect some of the ways in which the supply chain twin platform 21 conducts real-world actions related to a wellsite procedure. Although numerous use cases of the supply chain twin platform 21 have been described above, a person of ordinary skill in the art will readily appreciate that the supply chain twin platform 21 may be utilized in a variety of scenarios, and the real-world impacts of the supply chain twin platform 21 are not limited to the situations described herein.

Turning to FIG. 4, FIG. 4 depicts an example of a lookup table 79 that is searched by the materials module 49 to determine the required product(s) and part(s) needed to complete a particular wellsite procedure. As discussed above, the lookup table 79 may be stored, for example, on the memory 27, or stored on a remote data server (not shown) that is accessed with a wireless data connection (e.g., data connection 35). The lookup table 79 includes information that associates each potential wellsite procedure with the components necessary to complete the operation, such that the lookup table 79 forms the construction information described above.

As depicted in FIG. 4, the lookup table 79 is formed as a series of rows and columns. The rows correspond to various wellsite procedures that may be performed, while the columns relate to the products and parts associated with the particular wellsite procedure. Thus, the first column of the lookup table 79 is operation information 81 that lists each wellsite procedure that may be completed. In the example depicted in FIG. 4, the operation information 81 includes procedures such as, but not limited to, a new well drilling procedure (e.g., FIG. 6), a well plug installation procedure, a pressure sensor installation procedure, a payload procedure, a maintenance procedure, or equivalent procedures known to a person of ordinary skill in the art. By way of example, a new well drilling procedure (e.g., FIG. 6) may be a procedure to drill an exploratory well at a test wellsite. On the other hand, well plug installation and pressure sensor installation procedures relate to setting up additional devices, such as a cement plug for sealing a wellbore, or a downhole pressure sensor that measures the internal pressure of an existing wellbore. Similarly, a payload procedure includes procedures related to acquiring crude oils, gases, and other tangible commodities produced by an existing wellbore. Finally, a maintenance procedure takes the form of an operation to replace failed or damaged parts at a wellsite 17.

Continuing with the examples presented above, the second column of the lookup table 79 corresponds to product information 83 of product(s) that are used in the particular wellsite procedure. The product(s) are stored in the product information 83 column as a series of one or more Stock Keeping Units (SKUs) that uniquely identify the product(s) as described above. The SKUs may be input by the manufacturing facility, or retrieved from a remote global database of SKUs via the transceiver 23, for example.

As discussed above, products used for the process of drilling a new wellbore may include, for example, drill bits (e.g., FIG. 6), reamers, and stabilizers that are attached to a drilling rig. Thus, SKU 16849, which is depicted in the uppermost cell of the second column, identifies the particular drill bit, reamer, or stabilizer used in the drilling operation. Similarly, SKU 16142 corresponds to a well plug and SKU 17469 corresponds to a pressure sensor that may be installed at the wellbore during an installation operation. Furthermore, because the payload operation may include operations such as drilling a new section of an existing wellbore, SKU 26583 corresponds to a second size of drill bit (i.e., a drill bit with a different SKU than the drill bit used to drill a new well) used to drill the section of wellbore. Finally, SKU 75209 demonstrates, for example, an SKU of diagnostic equipment used at the wellsite 17 to determine any faults in parts or products used in the wellsite procedure.

Similar to the product information 83, the third column of the lookup table 79 includes part information 85 that specifies any part(s) from a supplier facility 15 that are required to complete a particular wellsite procedure. Thus, and continuing with the examples above, an SKU of 85682 in the part information 85 represents, for example, parts such as a section of a drill string that supports the drill bit(s), stabilizer(s) and reamer(s) identified by SKU 16849 depicted in the product information 83. An SKU 76021 in the part information 85 may represent, for example, a bushing of a well plug identified by SKU 16142, while the SKU 09483 corresponds to a wiring harness that is attached to the pressure sensor identified by SKU 17469. The cells that correspond to the “payload” and “maintenance” operations are respectively labeled as “N/A” (Not Applicable) and “TBD” (To Be Determined). The label “N/A” represents that no additional parts are required from a supplier facility 15 to complete a payload operation. On the other hand, the label “TBD” indicates that additional SKUs will be written to the part information 85 based upon the results of the maintenance operation. As the maintenance operation is in the process of being completed, the value of the cell updates periodically to indicate that no additional parts are necessary (“N/A), to indicate the SKU of any required parts that are to be replaced, or to reflect that the diagnostic portion of the maintenance operation has not yet been completed (TBD).

In addition, the fourth column of the lookup table 79 stores price information 90 of the parts stored in the product information column 83. Specifically, the price of each part is extracted from the PO corresponding to the part by the purchase order module 41, which includes the time that a part was received, the quantity of received part(s), and the cost thereof. The purchase order module 41 then proceeds to input this price information into the price information 90 column, or transmits this information to the workflow module 55 for the workflow module 55 to input the price information into the lookup table 79 directly. As additional POs are received for additional part shipments, the purchase order module 41 further determines the difference in price from the previous shipment to the current shipment, and stores this difference as a percentage in the price information 90. Thus, as depicted in Table 1, the uppermost cell of the price information 90 has a value of “$2.56 (−7%)”, which describes that the current cost of a part with SKU 85682 is $2.56, which is a 7% decrease from the previous shipment cost per part.

While the product information 83 and part information 85 columns describe the required products and parts needed to complete a particular wellsite procedure, the dependency information 87 captured in the lookup table 79 reflects any dependent products or parts necessary to use the products and parts of the product information 83 and the part information 85 columns. For example, and as described above, the well drilling procedure requires the use of a product with SKU 16849 (e.g., a drill bit), and a part with SKU 85682 (e.g., a drill string section). Thus, the dependent parts and/or products have SKUs of 15873 and 15874, which identify parts such as a Bottom Hole Assembly (BHA) and a drill collar that are used in conjunction with the drill bit and drill string section (e.g., the required products and parts for the wellsite procedure). As there are no dependent parts required for the well plug installation procedure and the payload procedures, these cells read “N/A”. Furthermore, the pressure sensor installation procedure has a dependent product/part with an SKU of 15862, which identifies a component such as a power source (e.g., a battery) or a casing assembly for the pressure sensor with an SKU of 17469. Finally, the cell of the dependency information 87 corresponding to the maintenance operation reads “TBD” to indicate that additional product and part SKUs will be added based upon the diagnosis of the failing products and/or parts at the wellsite 17.

However, cases may exist where substitute products and parts are used during the wellsite procedure. For example, and as described above, a manufacturing facility 13 may not be able to produce enough drill bits (e.g., identified by SKU 16849) to complete a new well drilling operation. In this case, the lookup table 79 includes substitute data in the form of substitute product information 89 and substitute part information 91, which form the sixth and seventh columns of the lookup table 79, respectively. More specifically, the substitute product information 89 includes a list of SKUs of products that are interchangeable with the products reflected by the product information 83. Similarly, the substitute part information 91 includes a list of any parts produced by the manufacturing facility 13 that are interchangeable with parts from the part information 85. In the event that any of the products and parts in the dependency information 87 have substitute counterparts, their SKUs are captured in the substitute product information 89 and the substitute part information 91 as well. Furthermore, in the event that no substitute products and/or parts are available or known for a wellsite procedure, the cells related to that particular procedure recite “N/A” to represent the lack of information. Similarly, any cells that are updated in real time initially recite “TBD” to signify that the substitute data will be added at a later date. Such may be necessary, for example, during a maintenance operation where it is unclear what products or parts need to be replaced at a wellsite prior to the operation.

Finally, the last column of the lookup table 79 includes substitute part price information 92. As discussed in relation to the price information 90, the substitute part price information 92 is determined by the purchase order module 41 based upon previous POs of substitute parts received by the manufacturing facility 13. Alternatively, the data may be manually input by an operator via the HMI 31 and the UI 37. As one example of the substitute part price information 92, the uppermost cell of the substitute part price information 92 recites “$23.15 (+12%)”, which indicates that the current cost of a substitute part with an SKU of 37544 has a price of $23.75, which has risen 12% from the previous cost. In the event that the substitute part price information 92 is lower than the price information 90, the purchase order module 41 directs the drilling operations module 43 to alert the operator, via the tie-in plans or tie-in menu (e.g., FIG. 5) with a text label or icon, that the substitute parts are more cost effective for the wellsite procedure.

Accordingly, overall, FIG. 4 depicts an example embodiment of a lookup table 79 as described herein. In particular, the lookup table 79 forms construction information that relates the products and parts to each wellsite procedure, as well as any substitute products and parts that can be used to complete the wellsite procedure. In this way, the lookup table 79 is used by the supply chain twin platform 21 to determine if a particular wellsite procedure may be completed as described above.

However, the lookup table 79 only includes construction information related to the contemplated wellsite procedure. On the other hand, product and part inventory information is stored in an AI database as further depicted in Table 1, below.

TABLE 1
AI Database

| | | Req. | Pr | Reg. | Pa | Prod. | Part | For. | For. | S. | Prod | Part | O. |
|---|---|---|---|---|---|---|---|---|---|---|---|---|---|
| Op. | TTC | Product | LT | Parts | LT | Inv. | Inv. | Prod. | Part | Risk | Risk | Risk | Risk |
| Well 1 | 36 | 16849:6 | 8 | 15873:12 | 4, 4 | 16849:1; | 15873:3; | 5, −1 | 12, 0; | 0.8 | 1 | 0.9 | 0.9 |
| | | | | 15874:12 | | Jul. 29, 2023 | Sep. 2, 2023 | | 12, 0 | | | | |
| | | | | | | | 15874:3; | | | | | | |
| | | | | | | | Aug. 10, 2023 | | | | | | |
| Well 2 | 247 | 16849:6 | 8 | 15873:12 | 4, 4 | 16849:1; | 15873:3; | 25, 19 | 64, 40; | 0.2 | 0.1 | 0 | 0.1 |
| | | | | 15874:12 | | Jul. 29, 2023 | Sep. 2, 2023 | | 64, 40; | | | | |
| | | | | | | | 15874:3; | | | | | | |
| | | | | | | | Aug. 10, 2023 | | | | | | |
| Plug | 1,216 | 16142:1 | 36 | N/A | N/A | 16142:1; | N/A | 34, 33 | N/A | 0 | 0 | N/A | 0 |
| | | | | | | Jul. 18, 2023 | | | | | | | |

More specifically, Table 1 depicts an example of an Artificial Intelligence (AI) database 101 and outputs stored therein consistent with one or more embodiments of the described invention. Similar to the lookup table 79 depicted in FIG. 4, the Table 1 (i.e., the AI database 101) is formed as a series of rows and columns, where the rows correspond to potential wellsite procedures and the columns correspond to data related to a particular wellsite procedure. Thus, for exemplary purposes only, a scheduled operations column (i.e., the first column labeled “Op.”) of Table 1 includes a first well drilling operation (i.e., “Well 1”), a second well drilling operation (i.e., “Well 2”), and a well plugging operation (i.e., “Plug”). The well drilling operations are, for example, operations that involve using a drilling rig and drill bit to drill an experimental wellbore. The plugging operation, on the other hand, is an operation to install a cement (or equivalent material) well plug at a wellsite 17.

Each scheduled operation reflected in Table 1 is associated with a scheduled date, which is selected by an operator in the UI 37 as further discussed below. The date is reflected in the second column (i.e., the Time to Completion “TTC” column) of Table 1, where each cell of the TTC column specifies the amount of time, in hours, between a current time and the scheduled time of the wellsite procedure. Thus, as depicted in Table 1, the first new well procedure is scheduled to take place in 36 hours, while the second new well procedure is scheduled for 247 hours from a current time and the plugging operation is scheduled for 1,216 hours from a current time.

The products and parts necessary to complete the scheduled wellsite procedure are stored in the required products column (i.e., the third column labeled “Req. Product”) and the required parts column (i.e., the fifth column labeled “Req. Parts”), respectively. As discussed in relation to FIG. 4, the required products and parts are stored in a lookup table 79, and are copied into the AI database (i.e., Table 1) by the materials module 49. This allows the AI model forming the demand quantity prediction module 51 and the demand risk prediction module 53 to forecast the demand and risk for a particular product or part, and further determine the overall risk of a scheduled wellsite procedure as a whole. The products and parts are stored as SKUs in the required products column (i.e., the third column labeled “Req. Product”) and the required parts column (i.e., the fifth column labeled “Req. Parts”), respectively, such that each cell includes the SKUs of products or parts associated with a specific wellsite procedure.

In order to better forecast the availability of products and parts for the wellsite procedures, Table 1 further includes a product lead time column (i.e., the fourth column labeled “PrLT”) and a part lead time column (i.e., the sixth column labeled “Pa LT”). These columns specify a forecast amount of time, in hours, determined by the workflow module 55, required for a manufacturing facility 13 to build the products and the supplier facility 15 to form the parts.

More specifically, the workflow module 55 is configured to derive the amount of lead time required to fulfill a Purchase Order (PO) for a part by determining the difference between a time when the PO was submitted and when a barcode identifying the part(s) requested in the PO is scanned at a manufacturing facility 13. As discussed above, the inventory data used to determine the moving average is received or determined by the workflow module 55 using scanners 29 or the supplier module 47, for example. The inventory data is stored in a current product quantity column (i.e., the seventh column labeled “Prod. Inv.”) and a current part quantity column (i.e., the eighth column labeled “Part Inv.”) in the form of timestamped data, as further discussed below. Thus, to compute the moving average, the workflow module 55 computes an average of the timestamped data for each product and part of the current product quantity column (i.e., the seventh column labeled “Prod. Inv.”) and the current part quantity column (i.e., the eighth column labeled “Part Inv.”), respectively. As each PO is submitted and fulfilled, the workflow module 55 updates this value to reflect the additional PO, such that the part lead time column (i.e., the sixth column labeled “Pa LT.”) reflects a real-time moving average of the total inventory received by the manufacturing facility 13. Similarly, the fourth column (i.e., the column labeled “Pr LT”), which relates to the lead time for a manufacturing facility 13 to form a product, is determined based upon a time between parts being scanned at a manufacturing facility 13 and an operator scanning an assembled product formed from the parts. Additionally, the moving average may only be determined for a period of previous time (e.g., the past 6 months), such that the part lead time column (i.e., the sixth column labeled “Pa LT.”) reflects the current ability of the supplier facility 15 to ship parts, without being influenced by previous computed averages. Similar restrictions may be placed upon the product lead time column (i.e., the column labeled “Pr LT”) without departing from the nature of this specification.

For example, the first and second well drilling operations reflected by the first and second rows of Table 1 use the same product (e.g., SKU 16849) to perform the new well drilling operation. Thus, the lead time to form the products is the same for the first and second rows of Table 1, and reflects that the product (e.g., SKU 16849) will take at least 8 hours to build after a manufacturing facility 13 has received the materials and/or parts to make the products from a supplier facility 15. Continuing with the example, and as described above, SKU 16849 may correspond to a drill bit used to drill the new well. In this case, the period of 8 hours reflects the time for a manufacturing facility 13 to manufacture a drill bit after an operator has received and scanned the barcode of raw materials (e.g., tungsten carbide) used to form the drill bit. Similarly, a lead time of 4 hours in the part lead time column (i.e., the sixth column labeled “Pa LT”) implies that it will take at least 4 hours to for the supplier facility 15 to receive a PO, retrieve the raw materials (e.g., tungsten carbide) from a warehouse, and ship the raw materials to the manufacturing facility 13.

As discussed above, the number of requisite products and the number of requisite parts are input into the supply chain twin platform 21 by an operator via the drilling operations module 43, where the operator manually inputs the amount of products with the HMI 31, or configured in the materials module 49 directly while setting up the supply chain twin platform 21 for a particular manufacturing facility 13. For example, when an operator of the supply chain twin platform 21 selects a particular wellsite procedure on the UI 37, the operator is presented with a menu (i.e., a tie-in menu) that allows the operator to select additional parts and/or products for the operation and quantities thereof. The number of required products is then stored in lookup table 79, and copied into Table 1 in the required product quantity column (i.e., the third column labeled “Req. Product”). Similarly, the number of required parts needed to complete a wellsite procedure is stored on the lookup table 79 and copied into the required part column (i.e., the fifth column labeled “Req. Parts”).

Similar to the required product quantity column, an AI database as described herein further includes a current product quantity column (i.e., the seventh column of Table 1 labeled “Prod. Inv.”) that details the current inventory reserves of products used in the wellsite procedure(s) that are located at the manufacturing facility 13. The information reflected in this column is determined for example, by having the demand quantity prediction module 51 subtract the number of products that have been previously used in wellsite procedures from a total number of products formed. Alternatively, the current product inventory may be periodically updated following an inventory process at the manufacturing facility 13. For example, the demand quantity prediction module 51 may be configured to rewrite the values of the current product quantity column (i.e., the seventh column labeled “Prod. Inv.”) to correspond to the number of products scanned by operators with scanners 29 and the times thereof, where the products are collectively scanned in a short period of time at the manufacturing facility 13. For example, the uppermost cell of the current product quantity column (i.e., the seventh column labeled “Prod. Inv.”) has a value of “16849:1; Jul. 29, 2023”, which implies that on Jul. 29, 2023 an operator scanned one product with an SKU of 16849 at a manufacturing facility 13.

Similarly, a current part quantity column (i.e., the eighth column labeled “Part Inv.”) corresponds to the number of parts and/or raw materials possessed by the supplier facility 15. The part quantity data may be automatically fed into the AI database (e.g., Table 1) as new supplier inventory data is submitted via the supplier module 47, for example. Additionally, the current part quantity column (i.e., the eighth column labeled “Part Inv.”) reflects quantities of the parts located at the manufacturing facility 13, which are scanned by the operators with scanners 29 as discussed above. For example, the uppermost value of the current part quantity column (i.e., the eighth column labeled “Part Inv.”) recites “15873:3; Sep. 2, 2023” and “15874:3; Aug. 10, 2023”, which describes that three parts with an SKU of 15873 were received on Sep. 2, 2023, and three parts with an SKU of 15874 were received on Aug. 10, 2023. Thus, the current product quantity column and the current part quantity column (i.e., the seventh and eighth columns of Table 1) are forms of the manufacturer inventory data and supplier inventory data, respectively, as discussed above.

Based upon a combination of all of the columns of Table 1 discussed above, the demand quantity prediction module 51 determines a forecast quantity of available products and a forecast quantity of available parts to be used in the wellsite procedure. The forecast quantity of available products is stored in the forecast available product quantity column (i.e., the ninth column labeled “For. Prod.”), while the forecast quantity of available parts is stored in the forecast available part quantity column (i.e., the tenth column labeled “For. Part.”). The values of the cells forming the forecast available product quantity column (i.e., the ninth column labeled “For. Prod.”) are determined based upon the relationship between the cells of the remaining time column, the product lead time column, the required product quantity column, and the current product quantity column, which are the second, fourth, third, and seventh columns of Table 1, respectively.

In particular, and by way of example, the value of “5, −1” in the uppermost cell of the forecast available product quantity column represents that a total of 5 products with an SKU of 16849 are likely to be available for use in the wellsite procedure, and that this quantity is one less than the required quantity. The value of 5 is derived from the fact that the manufacturing facility 13 is currently in possession of 1 product with SKU 16849 (i.e., the value in the current product quantity column), and the wellsite procedure is scheduled to be completed in 3 days (i.e., the value of the remaining time column). Based upon the remaining time being 36 hours, and that it will take 8 hours to form a product (i.e., the lead time in the product lead time column), the demand quantity prediction module 51 determines that an additional 4 products may be formed during the remaining time. The demand quantity prediction module 51 proceeds to add the current inventory (i.e., 1) to the number of additional products that may be formed (i.e., 4), and the summation thereof forms the forecast quantity of available products reflected in the cells of the forecast available product quantity column (i.e., the “Pr LT” column of Table 1). This process is further repeated for the second new well operation, in which case the demand quantity prediction module 51 concludes that 31 products with SKU 16849 (e.g., a drill bit) may be built in the remaining 247 hours.

The forecast number of available parts reflected in the “For. Part” column is determined by the demand quantity prediction module 51 using similar methods and algorithms. For example, a particular wellsite procedure requires the use of 24 parts total, in the form of a series of two SKUs (e.g., SKUs 15873,15874) with a required quantity of 12 parts each. Based upon the lead time for the parts being 4 hours each, and there being a total of 36 hours before the wellsite procedure is completed, the demand quantity prediction module 51 concludes that a quantity of 9 of each part may be built in the remaining time. As the current part quantity column (i.e., the eighth column of Table 1) indicates that a manufacturing facility 13 possesses 3 parts in its inventory, the demand quantity prediction module 51 concludes that 12 parts with SKU 15873 and 12 parts with SKU 15874 may be received by the manufacturing facility 13 prior to the wellsite procedure. Similarly, because the second wellsite procedure uses the same parts and products as the first wellsite procedure, the demand quantity prediction module 51 determines that 64 of each part may be built in the remaining 247 hours prior to the second new well procedure. As the well plug operation does not have any required parts, the demand quantity prediction module 51 writes a value of “N/A” to the cell of the current part quantity column corresponding to the well plug operation.

After computing the values of the forecast available product quantity column and the forecast available part quantity column, which make up the ninth and tenth columns of Table 1, the demand quantity prediction module 51 proceeds to determine if there's a product and/or part deficit, and appends this data to the forecast products and forecast parts columns. In particular, the forecast product deficit data is determined by subtracting the forecast available product quantity column from the required product quantity column (i.e., the ninth and third columns of Table 1, respectively). This value represents the potential difference between the amount of products that a manufacturing facility 13 may build and the amount of products necessary to complete the wellsite procedure. Similarly, the forecast part deficit data reflects the difference between the forecast available part quantity column and the required part quantity column (i.e., the tenth and fifth column of Table 1, respectively). A positive value indicates that the manufacturing facility 13 is in possession of all required products and parts to complete the wellsite procedure, while a negative value indicates that the wellsite procedure cannot be completed as a consequence of not having enough products and/or parts. For example, and concerning the first new well operation, the forecast product column is updated to include a value of “5, −1”, where the value of “−1” indicates that a supplier facility 15 will not possess at least one of the products with SKU 16849. On the other hand, the forecast part column (i.e., the tenth column of Table 1) indicates that a manufacturing facility 13 will possess the exact number of parts with SKUs 15873 and 15874 (i.e., a part deficit of zero indicated by the value of “0” in the string “12,0”) that are required to complete the first new well operation.

The values of the forecast product quantity column and the forecast part quantity column for a particular wellsite procedure may further be influenced by the amount of parts and products required to complete a previous wellsite procedure. For example, based upon the lead times required to build the products used in the second new well operation, the demand quantity prediction module 51 has forecast that a total of 31 products may be built, in addition to the 1 product that the manufacturing facility 13 currently possesses. However, because the second new well operation is scheduled after the first well operation, and the well operations use the same products, the demand quantity prediction module 51 subtracts the 6 products from the product deficit value reflected in the forecast product quantity column, such that this cell reads that 25 products are forecast to be available for the second wellsite procedure with a potential surplus of 19 products. In this way, the demand quantity prediction module 51 as a whole is configured to consider any relationships between operations to ensure that the operations may be completed while also accounting for products and parts used in the other wellsite procedures.

After determining the forecast product deficit and the forecast part deficit, the demand risk prediction module 53 determines values of a scheduling risk column (i.e., the eleventh column labeled “S. Risk”), a product risk column (i.e., the twelfth column labeled “Prod Risk”), a part risk column (i.e., the thirteenth column labeled “Part Risk”), and an overall risk column (i.e., the fourteenth column labeled “O. Risk”). The values of the scheduling risk column correspond to a scheduling risk associated with the particular wellsite procedure, and are determined as a function of the values of the remaining time column (i.e., the “TTC” column of Table 1). More specifically, the demand risk prediction module 53 assigns a weight, as a decimal value between 0 and 1, inclusive, based upon the amount of hours remaining before the wellsite procedure. In this regard, the demand risk prediction module 53 assigns and rewrites the value of this column to increase corresponding to the decrease in time, such that a high weight (e.g., 1) represents that a wellsite procedure is scheduled to occur in the immediate future, while a low weight (e.g., 0) represents that a wellsite procedure is scheduled to occur in the distant future. Thus, as depicted in Table 1, the first new well operation, which is scheduled for 36 hours from a current time, is associated with a weight of 1 (since it is close to the current time), while the well plug operation, which is scheduled for 1,216 hours from now, has a weight of 0. The rate of decay of the weights, as well as when the weights have values of 1 and 0, may be input by an operator while configuring a supply chain twin platform 21 for a particular manufacturing facility 13.

In addition, the demand risk prediction module 53 considers the relationship between the forecast available product quantity column, the forecast available part quantity column, and the remaining time column (i.e., the ninth, tenth, and second columns, respectively) when determining the product risk and the part risk. More specifically, the product risk column (i.e., the twelfth column of Table 1, labeled “Prod Risk”) is a weight with a value that corresponds to the risk of forming the required number of products prior to the scheduled date of the wellsite procedure.

For example, and as depicted in Table 1, the cell of the forecast product column for the first new well operation has a string of “5, −1”, where the value of “−1” indicates indicating that the manufacturing facility 13 will likely not have enough products to complete the first new well operation. On this basis, the demand risk prediction module 53 determines that there is a high risk that the first new well will not be drilled, and assigns a high weight of 1 to the uppermost cell of the product risk column. Similarly, because the manufacturing facility 13 is forecast to have the exact amount of parts for the first new well operation, the demand risk prediction module 53 assigns a relatively high risk weight of 0.9 to the uppermost cell of the part risk column (i.e., the thirteenth column of Table 1). On the other hand, because it is highly likely that the manufacturing facility 13 will be able to receive the products and parts necessary to complete the second new well procedure in the remaining 247 hours therebefore, the demand risk prediction module 53 assigns low risk weights of 0.1, and 0, respectively, to the scheduling risk column and the product risk column (i.e., the eleventh and twelfth columns of Table 1) for the second new well operation. Furthermore, because the manufacturing facility 13 already possesses the required number of products to complete the well plugging operation, the demand risk prediction module 53 determines that there is no product risk with the well plugging operation, and assigns a weight of 0 to this cell in the product risk column.

The overall risk column (i.e., the fourteenth column of Table 1) is an averaging column that is used by the demand risk prediction module 53 to determine the total level of risk associated with the wellsite procedure. Thus, to determine the values of the overall risk column, the demand risk prediction module 53 performs an averaging function on the values of the scheduling risk column, the product risk column, and the part risk column (i.e., the eleventh, twelfth, and thirteenth columns of Table 1) to derive the overall risk weight. The averaging function may be, for example, a simple average of the values, or a weighted average based upon the weights in the individual columns. For example, in a case where a wellsite procedure is scheduled in the immediate future and the manufacturing facility 13 is in possession of all the required products, the demand risk prediction module 53 may reduce or otherwise modify the value of the scheduling risk column since the remaining time is no longer a relevant factor to the completion of the wellsite procedure. Thus, the overall risk column (i.e., the final column of Table 1) reflects the final determination of whether a wellsite procedure is likely to be completed, where a high value indicates a high risk that the wellsite procedure will not be completed, and a low value indicates that the wellsite procedure will likely be completed at the scheduled date.

FIG. 5 depicts an example of a UI 37 consistent with one or more embodiments of the invention as described herein. The UI 37 is primarily formed of four graphical elements, which include a well menu 93, a tie-in menu 95, tie-in plans 97, and a calendar 99. As discussed above, the well menu 93 includes a drop-down menu of wellsite procedures 145 that an operator can schedule using the supply chain twin platform 21. As depicted in FIG. 5, and as one example of potential wellsite procedures that can be scheduled, the well menu 93 includes procedures such as a new well drilling procedure, a well plug installation procedure, a pressure sensor installation procedure, a payload procedure, and a maintenance procedure. The well menu 93 also includes dates in a date menu 147 that the various procedures may be scheduled for, such that an operator of the supply chain twin platform 21 selects the wellsite procedure and a corresponding date in order to schedule a wellsite procedure. The various wellsite procedures and the potential dates for the procedures reflected in the date menu 147 are stored on the memory 27 and are generated and maintained by the drilling operations module 43. Dates and procedures available to the operator may be input manually via the HMI 31, or determined by the supply chain twin platform 21 based upon other current and previous wellsite procedures. For example, the drilling operations module 43 may present a list of dates that are a predetermined amount of time (e.g., 3 days) from any other scheduled wellsite procedure.

Once a particular wellsite procedure is selected with the well menu 93, the tie-in menu 95 provides an interface for the operator to view and select product and parts to be used in the selected procedure. Thus, the tie-in menu 95 includes a list of the required and substitute product(s) and part(s) used in the wellsite procedure, as well as a checkbox 139 for selecting whether substitute products and parts may be used in the procedure. For example, in a case where the operator selects a new well drilling operation, the tie-in menu 95 depicts that the drilling operation requires a product with an SKU of 16849, or substitute products with SKUs of 16750 and 18651, since the checkbox 139 is checked. The tie-in menu 95 further includes a list of the required parts for the drilling operation, which includes SKUs of 15873 and 15874, or substitute parts with SKUs of 37544 and 37545. As discussed above, products and parts depicted in the well menu 93 and the tie-in menu 95 are stored in the lookup table 79 by the materials module 49, and retrieved by the drilling operations module 43 to be displayed on the UI 37.

The tie-in menu 95 further includes an additional components menu 141 that allows the operator to select additional products and parts to be used in the wellsite procedure selected in the well menu 93. As depicted in FIG. 5, the additional components menu 141 includes a component drop-down menu 149 specifying additional products and parts that may be used in the wellsite procedure, as well as a quantity input box 151. The component drop-down menu 149 includes a list of products and/or parts returned from the materials module 49, which includes some or all of the products and parts possessed by the manufacturing facility 13. The list may further only include products and parts that have previously been used (but are not indicated as being required) in a similar wellsite procedure, or the list may be manually formed by an operator or owner of the supply chain twin platform 21 when the supply chain twin platform 21 is configured for a particular manufacturing facility 13. Once an additional component (i.e., a product or part) is selected with the component drop-down menu 149, the operator manually enters the quantity of the required part in the quantity input box 151. Subsequently, the tie-in menu 95, the lookup table 79, and the AI database 101 are updated to include the additional components as required products or parts for the procedure. In this way, the operator that selects and schedules a wellsite procedure is able to select additional components and quantities thereof, which allows a generic wellsite procedure to be adapted to the specific logistics of a particular wellsite procedure.

As one example of where the tie-in menu 95 may be beneficial, a specific new well drilling operation may be scheduled for a wellsite with a large amount of bedrock, such that the drilling operation will be more difficult than previously completed well drilling operations. In this case, the operator may determine that additional drill bits (e.g., SKU 17643) are required for the specific new well drilling operation, as all of the drill bits are expected to fail while drilling through the bedrock. The operator then proceeds to select SKU 17643 (which corresponds to the drill bit used in the operation), as well as the estimated quantity of additional drill bits needed. This, in turn, ensures that the supply chain twin platform 21 as a whole schedules the specific new well drilling operation for a time when the additional drill bits may be acquired, and further ensures that the manufacturing facility 13 is aware that it must acquire or form additional drill bits before the operation.

While the well menu 93 and the tie-in menu 95 serve to allow an operator to schedule and modify potential wellsite procedures, the tie-in plans 97 and the calendar 99 serve to present information back to the operator concerning the status of the scheduled wellsite procedures. More specifically, the calendar 99 presents a graphical depiction of a current month, as well as a checkmark on any days that a wellsite procedure is selected. This allows the operator to quickly verify which days that wellsite procedures are scheduled for, and further offers the operator the ability to visually double-check that a wellsite procedure has been scheduled for the correct date. In addition, an operator may click on the checkmark, or the date associated therewith, in which case the tie-in plans 97 presents information related to the wellsite procedure for that date. For example, and as depicted in FIG. 5, the calendar 99 reflects that a wellsite procedure is scheduled for the 7th of September 2023. Once the operator selects the date of September 7th, the UI 37 graphically superimposes a circle onto the selected date, which is depicted as the selected date 153, which further allows the operator to visually verify that the correct date is selected.

Continuing with the example where the operator selects a date of September 7th, the tie-in plans 97 present an overview of the scheduled wellsite procedure. More specifically, and as depicted in FIG. 5, the tie-in plans 97 specifies that the wellsite procedure is a new well drilling procedure that involves drilling an exploration well, which is commonly used to determine if a wellsite 17 is suitable for future payload operations. The tie-in plans 97 further present the date of the new well drilling procedure (e.g., September 7th), as well as any interconnectivity between the scheduled wellsite procedure and previously completed procedures. The interconnectivity field presents information to the operator describing if the new well connects to an existing well, for example. However, because in the example described above an exploration well is being drilled, there is no interconnectivity information for this particular procedure. The tie-in plans 97 further presents the associated risk with a particular wellsite procedure, which is equivalent to the overall risk determined in the overall risk column (i.e., the last column of Table 1) described above. The above data presented in the tie-in plans 97 may be retrieved, for example, from the AI database 101 using the drilling operations module 43, or fed directly to the UI 37 from the demand quantity prediction module 51.

In addition to presenting the logistical parameters of the wellsite procedure, the tie-in plans 97 further include a live feed 155 that presents real-time data related to the scheduled wellsite procedure. Continuing with the example of drilling an exploration well, the drilling rig used to drill the exploration well is equipped with a downhole pressure sensor that measures the internal pressure of the exploration well as it is being drilled (e.g., FIG. 6). Thus, the live feed 155 presents the downhole pressure of the exploration well in real-time, and is depicted as being a value of 4,000 psi in FIG. 5. The data presented in the live feed 155 is transmitted to the supply chain twin platform 21 by way of the transceiver 23, for example, which forms a wireless data connection with the downhole pressure sensor (e.g., FIG. 6) used in the wellsite procedure. Once the wellsite procedure is completed, the operator selects that the wellsite procedure is completed by selecting a procedure completion checkbox 157, which informs the supply chain twin platform 21 that the particular wellsite procedure is complete. In the event that the downhole pressure sensor stops transmitting live data prior to an operator indicating that the wellsite procedure is complete via the procedure completion checkbox 157, the supply chain twin platform 21 concludes that the wellsite procedure has failed, and reschedules the wellsite procedure for a later date automatically by way of the drilling operations module 43 as described above. In this way, the supply chain twin platform 21 is further configured to respond, in real time, to the wellsite procedure and any challenges that arise as a consequence thereof.

Turning to FIG. 6, FIG. 6 depicts a wellsite 17 consistent with one or more embodiments of the invention described herein, and more specifically depicts a wellsite 17 at which a new wellbore 159 is being drilled. In general, well sites are configured in a myriad of ways. Therefore, the wellsite 17 is not intended to limit the particular configuration of the drilling equipment. For example, the wellsite 17 is depicted as being on land, however the wellsite 17 may be offshore and drilling may be carried out with or without the use of a marine riser. Moreover, various components and details of the wellsite 17 that would be well known to a person of ordinary skill in the art have been omitted for the sake of brevity.

A drilling operation at the wellsite 17 is initiated by drilling a wellbore 159, or borehole, into a subterranean formation 161, which may be bedrock or soil, for example. More specifically, the process of drilling a wellbore 159 involves using a drilling rig 167 to rotate a drill bit 163. The drill bit 163 is disposed at the end of a bottom hole assembly 165, which is connected to a drilling rig 167 disposed at the surface of the wellsite 17. The drilling rig 167 is connected to the drill bit 163 by way of a bottom hole assembly 165 and a drill string 169, which are components that serve to orient the drill bit 163 within the wellbore 159 and assist the drill bit 163 in breaking down the subterranean formation 161. That is, and as is commonly known in the art, a drill string 169 is a series of tubes that transmit drilling mud (not shown) and torque to the bottom hole assembly 165 and drill bit 163, while a bottom hole assembly 165 includes components such as reamers and stabilizers (not shown) that position the drill bit 163 in the wellbore 159. Accordingly, the drilling rig 167 is configured to used internal components such as a crown block or power generation equipment (not shown) to apply a downward force on the drill string 169, which is transmitted to the drill bit 163 by way of the drill string 169 and the bottom hole assembly 165. In turn, this causes blades (not shown) of the drill bit 163 to scrape away the subterranean formation 161 to extend the wellbore 159. Thus, overall, the wellbore 159 is created by scraping away the subterranean formation 161 with the drill bit 163 using power supplied by the drilling rig 167.

As is further depicted in FIG. 6, the bottom hole assembly 165 includes a downhole pressure sensor 171 that serves to capture the internal pressure of the wellbore 159 as the drill bit 163 breaks down the subterranean formation 161. The downhole pressure sensor 171 may be, for example, a diaphragm type of pressure sensor that measures the displacement of a diaphragm as a function of the fluid pressure provided thereto. The downhole pressure sensor 171 is further equipped with a transmitter (not shown), that forms a data connection with the supply chain twin platform 21 using the transceiver 23, for example. During the process of drilling the wellbore 159, the downhole pressure captured by the downhole pressure sensor 171 is output to the tie-in plans 97 (e.g., FIG. 5), which allows an operator located away from the wellsite 17 to view the downhole pressure associated with the drilling operation. In this example, the downhole pressure sensor 171 is a product built by a manufacturing facility 13, while the drill string 169 supporting the downhole pressure sensor 171 is one example of a part formed by a supplier facility 15 as described above.

The data captured by the downhole pressure sensor 171 further allows the supply chain twin platform 21 to determine if additional wellsite procedures are necessary. For example, in the event that a supply chain twin platform 21 has not received confirmation that the wellsite procedure has been completed, and has stopped receiving data from the downhole pressure sensor 171, the supply chain twin platform 21 determines that the operation remains incomplete. In this case, the drilling operations module 43 of the supply chain twin platform 21 schedules an additional wellsite procedure to continue the process of drilling the new well, and confirms that an additional downhole pressure sensor is possessed by the manufacturing facility 13 such that the additional wellsite procedure may be completed. Additionally, the supply chain twin platform 21 is configured with predetermined minimum and maximum live data limits for each type of sensor that transmits live data thereto. In the event that the live data exceeds the predetermined limits, the supply chain twin platform 21 also concludes that the downhole pressure sensor 171 is faulty and needs to be replaced.

In the event that the manufacturing facility 13 does not possess any reserve inventory of the downhole pressure sensor 171, the supply chain twin platform 21 further submits a PO to the supplier facility 15, via the supplier module 47, that is fulfilled by the supplier facility 15 to enable the manufacturing facility 13 to complete the additional wellsite procedure. As discussed in relation to Table 1, the determination of whether the supply chain twin platform 21 needs to submit an additional PO relies upon the forecast available part quantity column (i.e., the column labeled “For. Prod.” in Table 1) and the forecast part deficit data (i.e., included in the “For. Part” column of Table 1) of the AI database 101. Thus, the downhole pressure data captured by the downhole pressure sensor 171 is used by the supply chain twin platform 21 to automatically reschedule failed wellsite procedures based upon real-time data thereof.

Furthermore, in a case where the failed product or part is not easily replaceable, the supply chain twin platform 21 may schedule wellsite procedures of a different type in order to account for the failed product or part. For example, in a case where a drilling rig drilling rig 167 breaks while performing a new well drilling procedure, and the supply chain twin platform 21 receives data that the drilling rig 167 can no longer function, it is insufficient for the supply chain twin platform 21 to reschedule the new drilling procedure, as the drilling rig 167 requires maintenance to proceed with the drilling procedure. In this case, the supply chain twin platform 21 concludes that a maintenance operation must be completed prior to the additional well drilling operations, and uses the drilling operations module 43 to schedule both operations. The determination that the drilling rig 167 itself has failed may be determined by the supply chain twin platform 21 based upon static (i.e., not changing) values of the live feed 155, which indicates that the wellsite procedure has paused. Thus, overall, the values provided by the downhole pressure sensor 171 allow the supply chain twin platform 21 to determine and facilitate the operation of the wellsite 17 as a whole, such that a contemplated wellsite procedure is automatically revised as logistical challenges arise during wellsite 17 operations.

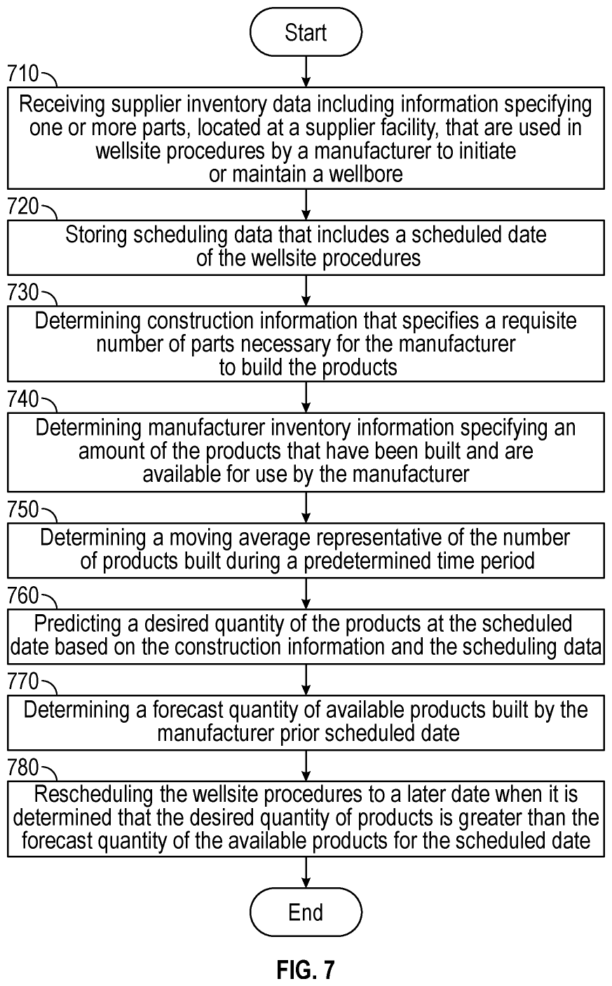

Turning to FIG. 7, FIG. 7 depicts a method for rescheduling a wellsite procedure according to one or more embodiments of the invention. Steps of FIG. 7 may be performed, for example, by the aforementioned supply chain twin platform 21, but are not limited thereto. The constituent steps of the method depicted in FIG. 7 may be performed in any logical order, and are not limited to the sequence presented. Furthermore, the steps of FIG. 7 may encompass multiple additional actions not depicted that are routine in the art. Moreover, multiple steps of FIG. 7 may be performed as part of a single action, or a single step may comprise multiple actions.

The method of FIG. 7 initiates at step 710, which requires receiving supplier inventory data including information specifying one or more parts, located at a supplier facility, that are used by a manufacturer facility 13 to build products used in wellsite procedures to initiate or maintain a wellbore. As noted above, the supplier inventory data reflects a number of parts produced and shipped by the supplier facility 15, and the phrase “parts” as used herein encompasses raw materials or subassembly components that are used by a manufacturing facility 13 to form various products to be used in a wellsite procedure. For example, and as discussed above, a “part” may encompass products such as a drill string 169 or a mounting assembly (not shown) for mounting a downhole pressure sensor 171 to a bottom hole assembly 165. Following the same logic, examples of wellsite procedures as described herein include drilling a new wellbore (e.g., FIG. 6), performing a well remediation operation, installing sensors to an existing wellbore, performing maintenance, and other related actions performed to extend the life and usefulness of a wellsite 17.

The supplier inventory data is captured at the supplier facility 15 using one or more scanners 29, where operators scan barcodes representing Stock Keeping Units (SKUs) of parts. The inventory data is then transferred from the supplier facility 15 to the manufacturing facility 13 by way of the data connection 35, which may be embodied as a wired or wireless data connection as described herein. The transfer of the supplier inventory data may further be facilitated by an Application Programming Interface (API) 39 of the supply chain twin platform 21, which provides a dedicated data transfer path and protocols that ensure the supplier inventory data is securely transmitted to the supply chain twin platform 21.

In step 720, the supply chain twin platform 21 receives and stores scheduling data related to the wellsite procedure. As discussed above, the scheduling data includes a location and date at which a wellsite procedure is scheduled to be completed, and is received by the supply chain twin platform 21 with a transceiver 23. To schedule the wellsite procedure, an operator of the manufacturing facility 13 selects a wellsite procedure using a UI 37 of the supply chain twin platform 21 that presents a well menu 93 of the drilling operations module 43 to the operator. Based on the selected wellsite procedure, the drilling operations module 43 returns available dates for the wellsite procedure, which may either be input manually by a managing entity of the supply chain twin platform 21 or automatically determined by the drilling operations module 43 according to available product inventory possessed by the manufacturing facility 13, for example. More specifically, the drilling operations module 43 may automatically select a date for the wellsite procedure based upon existing wellsite procedures, where a newly scheduled wellsite procedure is scheduled to a date within a predetermined time period that is a furthest possible date from other, currently scheduled wellsite procedures. As described above, the scheduled dates of wellsite procedures are stored in the lookup table 79 on the memory 27, and are written to the AI database 101 with the drilling operations module 43. Once a particular wellsite procedure is selected via the well menu 93 of the UI 37, the method proceeds to step 730.

In step 730, the supply chain twin platform 21 determines construction information that specifies a requisite number of parts necessary for the manufacturer to build the products. The construction information is stored and maintained by the materials module 49 on the memory 27, and is embodied as a lookup table 79 that relates each wellsite procedure to its required products and constituent parts. Thus, once a particular wellsite procedure is selected by an operator in step 720, the materials module 49 searches for the wellsite procedure in the lookup table 79 with the lookup function, and returns the parts associated therewith. Once the materials module 49 returns the requisite number of parts and identities thereof for completing the wellsite procedure, the method proceeds to step 740.

Step 740 includes determining manufacturer inventory information that specifies an amount of the products that have been built and are available for use by the manufacturer. Similar to the process for capturing the supplier inventory data, the manufacturer inventory information is captured by operators of the manufacturing facility 13 scanning SKU barcodes of assembled/completed products with a scanner 29, which may be a handheld scanner for example. As each barcode of the products is scanned, a workflow module 55 of the supply chain twin platform 21 updates the manufacturer inventory information (which is stored in the AI database 101, and reflected by the “Prod. Inv.” column of Table 1) to reflect the creation or assembly of a product. In the same way, as products are used at a wellsite or shipped from a manufacturing facility 13, barcodes of the products are scanned with a scanner 29, in which case the workflow module 55 decreases the amount of available product(s) in the AI database 101 (e.g., decreases the value of the “Prod. Inv.” column of Table 1). As noted above, the inventory information may further reflect any parts or products returned to the manufacturing facility 13 and scanned with a scanner 29, which may arise if the parts/products are damaged, or if a third party no longer needs a shipment of products from the manufacturing facility 13. Thus, the workflow module 55 captures real-time inventory information related to the number of products currently available to a manufacturer for use in the wellsite procedures, which reflects the status of both products that have been used and are unavailable, and products that are freshly assembled or produced and are available for use.

In step 750, the supply chain twin platform 21 determines the rate at which products are built at the manufacturing facility 13 by computing a moving average of the products over a predetermined time period. Due to the fact that the workflow module 55 periodically updates the manufacturing inventory information, the manufacturing inventory information itself takes the form of time-series data reflecting the product inventory of the manufacturing facility 13 at multiple points in time. Accordingly, the process of creating a moving average according to step 750 comprises taking a period of time, summing the number of products created during that period of time, and dividing the summation by the time period to generate the average for that time period. By taking multiple averages over a longer period of time, and by update the average to reflect new data, the workflow module 55 creates a moving average of the entire time-series data. In turn, the moving average is used to determine the lead time required to acquire a specific product or part, which is reflected in the product lead time column (i.e., the “Pr LT” column of Table 1) and part lead time column (i.e., the “Pa LT” column of Table 1), respectively. Based upon the lead time required to acquire the additional products and parts, the supply chain twin platform 21 forecasts an available quantity of products for use in the wellsite procedure as described below.

In step 760, a required quantity of the of the products to be used by the manufacturing facility 13 during the wellsite procedure on the scheduled date is predicted based on the construction information and the scheduling data. As described above, the drilling operations module 43 stores the scheduling data in the scheduled operations column of the AI database 101 (i.e., the “Op.” column of Table 1) and the materials module 49 further stores construction information in the lookup table 79. The construction information of the lookup table 79 details assembly information for the products, and includes a list of parts that are required to build a particular product, stored in the form of a lookup table. Furthermore, in the event that a product requires multiple specific parts, the construction information formed by the lookup table 79 further details the amount of parts necessary for the individual product. Thus, step 760 includes the materials module 49 receiving a wellsite procedure from the drilling operations module 43, which retrieves the value from the AI database 101 (i.e., Table 1), and retrieving the types and quantities of products associated with the wellsite procedure, as well as any parts required to build the products, from the lookup table 79.

Once the supply chain twin platform 21 has acquired the scheduling data, the construction information, the supplier inventory data, and the manufacturing inventory information, a demand quantity prediction module 51 forecasts an available quantity of the products at the scheduled date in step 770. Specifically, the demand quantity prediction module 51 forms relationships that relate the various inventories described above with the amount of time between the current date and a scheduled date of the wellsite procedure, which is reflected in the forecast available product quantity column (i.e., the “For. Prod.” column of Table 1) of the AI database 101. In one embodiment of the invention, for example, a boosted trees algorithm employed by the demand quantity prediction module 51 forms a relationships between the lead times (computed based upon the moving averages) of the product lead time column (i.e., the “Pr LT” column of Table 1) and part lead time column (i.e., the “Pa LT” column of Table 1), and the amount of time remaining in the remaining time column (i.e., the Time to Completion “TTC” column of Table 1). Based upon this relationship, the supply chain twin platform 21 determines the amount of products and parts that may be acquired by the manufacturing facility 13 prior to the wellsite procedure, which is stored in the forecast available product quantity column (i.e., the “For. Prod.” column of Table 1) and the forecast available part quantity column (i.e., the “For. Part” column of Table 1) of the AI database 101 as described above. Accordingly, overall, step 770 comprises forming a relationship between the scheduled date of the wellsite procedure and the amount of products and parts that may be acquired by the manufacturing facility 13 prior to the wellsite procedure.

In step 780, the wellsite procedure is rescheduled by the drilling operations module 43 according to the required quantity of products determined in step 760 and the forecast quantity of available products determined in step 770. In particular, a case may arise where the forecast quantity of available products is forecast to be less than a required quantity of products, such that the wellsite procedure will not be completed by the scheduled date. Such a case occurs, for example, when the forecast part deficit is a negative number, which is reflected by the value of “5, −1” of the uppermost cell of the “For. Prod.” column of Table 1. In this case, the drilling operations module 43 of the supply chain twin platform 21 accesses its calendar 99 and the list of other wellsite procedures from the AI database 101, as well as the inventory data forecast to be used in association with the other wellsite procedures. The drilling operations module 43 then selects a new date for the rescheduled wellsite procedure within a predetermined time period (e.g., one week) from its originally-scheduled date. Alternatively, the new date is determined as a function of the other wellsite procedures, such that the new date is a date with the highest number of available products at the manufacturing facility 13 in the predetermined time period, or the first date that the required number of products is less than the forecast quantity of available products, which is determined using the times of the wellsite procedures reflected in the remaining time column (i.e., the “TTC” column of Table 1). In turn, this ensures that the wellsite procedure is advantageously completed at a date that minimizes the logistical impact of the wellsite procedure on the manufacturing facility 13, and further ensures that the manufacturing facility 13 possesses the products necessary to complete the wellsite procedure on the rescheduled date.

Accordingly, the aforementioned embodiments of the invention as disclosed relate to devices and methods useful for managing logistics related to a scheduled or contemplated wellsite procedure. In addition, embodiments of the invention are capable of performing real time actions related to the scheduled wellsite procedure, such as increasing or decreasing the production rate of the manufacturing facility based upon contemplated wellsite procedures. Furthermore, embodiments of the invention receive the benefits of a single, cohesive platform combines multiple sources of logistic data into an operable interface that facilitates the viewing and modification of the wellsite procedures by multiple different entities such as a manufacturer, a wellsite operator, and a supplier.

Although only a few embodiments of the invention have been described in detail above, those skilled in the art will readily appreciate that many modifications are possible in the example embodiments without materially departing from this invention. For example, the AI model employed by the supply chain platform may be supervised or unsupervised, and may use regression algorithms rather than the boosted trees algorithm described herein. Furthermore, the procedure completed by the manufacturing facility may reflect any number of wellsite procedures not discussed herein, or may encompass non-wellsite related procedures for commercially available products. Accordingly, all such modifications are intended to be included within the scope of this disclosure as defined in the following claims.

What is claimed is:

1. A digital supply chain twin system, the system comprising:
a transceiver configured to receive supplier inventory data, the supplier inventory data including information specifying one or more parts, located at a first supplier, that form one or more products that are used in one or more wellsite procedures by a manufacturer to initiate, maintain, or use a wellbore;
a processor configured to execute a series of modules forming a supply chain twin platform, the series of modules comprising:
a drilling operations module configured to store scheduling data that includes a scheduled date of the wellsite procedures;
a materials module configured to store construction information that specifies a requisite number of parts necessary for the manufacturer to build the products, and further configured to determine a requisite quantity of the products built by the manufacturer to be used during the wellsite procedures;
a workflow module configured to determine manufacturer inventory information specifying an amount of the products that have been built and are available for use by the manufacturer, and a moving average representative of the number of products built during a predetermined time period;
a demand quantity prediction module configured to predict, based on the construction information, the moving average, and the scheduling data, a forecast quantity of the available products built by the manufacturer prior to the scheduled date;
wherein the drilling operations module is further configured to reschedule the wellsite procedures to a later date when the demand quantity prediction module determines that the requisite quantity of products is greater than the forecast quantity of the available products for the scheduled date.

2. The digital supply chain twin system of claim 1, wherein the supply chain twin platform further comprises a demand risk prediction module configured to determine a likelihood that the requisite quantity of the parts to perform the wellsite procedures are unavailable at the scheduled date based upon one or more previous lead times for the first supplier to fulfil a part order.

3. The digital supply chain twin system of claim 1, further comprising: an Application Programming Interface (API) module configured to be installed on one or more computing devices belonging to the first supplier, and further configured to provide an interface for the first supplier to submit the supplier inventory data via the transceiver.

4. The digital supply chain twin system of claim 1, further comprising: a purchase order module configured to store previous purchase orders requesting a number of parts from the first supplier, and further store invoices associated with completed purchase orders.

5. The digital supply chain twin system of claim 1, wherein the supply chain twin platform further comprises an ad-hoc module configured to allow guest users to view the manufacturer inventory information.

6. The digital supply chain twin system of claim 1, wherein the series of modules forming the supply chain twin platform are stored on a memory comprising a non-transient storage medium.

7. The digital supply chain twin system of claim 1, wherein the products used in the wellsite procedures comprise one or more of a drill bit used to drill a section of the wellbore, a drill string used in the wellbore, and a sensor configured to determine a downhole pressure of the wellbore.

8. The digital supply chain twin system of claim 1, wherein the drilling operations module is further configured to monitor a real-time progress of the wellsite procedures.

9. The digital supply chain twin system of claim 1, wherein the materials module further comprises substitute data specifying components from a second supplier that are interchangeable with the parts from the first supplier.

10. The digital supply chain twin system of claim 1, wherein the digital supply chain twin system is further configured to determine a difference in price between a previous cost of the parts and a current cost of the parts.

11. A method for automatically ordering parts for use during one or more wellsite procedures, the method comprising:
receiving supplier inventory data with a transceiver of a digital supply chain twin system, the supplier inventory data including information specifying one or more parts, located at a first supplier, that form one or more products that are used in the wellsite procedures by a manufacturer to initiate, maintain, or use a wellbore;
executing, with a processor, a series of modules that form a supply chain twin platform, the execution comprising:
storing, with a drilling operations module of the supply chain twin platform, scheduling data that includes a scheduled date of the wellsite procedures;
storing, with a materials module of the supply chain twin platform, construction information that specifies a requisite number of parts necessary for the manufacturer to build the products;
determining, with a workflow module of the supply chain twin platform, manufacturer inventory information specifying an amount of the products that have been built and are available for use by the manufacturer;
determining, with the workflow module, a moving average representative of the number of products built during a predetermined time period;
storing, with the materials module, a requisite quantity of the products at the scheduled date based on the construction information and the scheduling data;
determining, with a demand quantity prediction module of the supply chain twin platform, a forecast quantity of available products built by the manufacturer prior to the scheduled date, and
rescheduling the wellsite procedures to a later date, with the drilling operations module, when the demand quantity prediction module determines that the requisite quantity of products is greater than the forecast quantity of the available products for the scheduled date.

12. The method of claim 11, further comprising: determining, with a demand risk prediction module of the supply chain twin platform, a likelihood that the requisite quantity of the parts to perform the wellsite procedures are unavailable at the scheduled date based upon one or more previous lead times for the first supplier to fulfil a part order.

13. The method of claim 11, further comprising: installing an Application Programming Interface (API) module on one or more computing devices belonging to the first supplier, the API module being configured to provide an interface for the first supplier to submit the supplier inventory data.

14. The method of claim 13, further comprising: storing, with a purchase order module of the supply chain twin platform, previous purchase orders that request a number of parts from the first supplier, and further storing invoices associated with completed purchase orders with the purchase order module.

15. The method of claim 11, further comprising: allowing guest users to view the manufacturer inventory information with an ad-hoc module of the supply chain twin platform.

16. The method of claim 11, further comprising: storing the series of modules forming the supply chain twin platform on a memory comprising a non-transient storage medium.

17. The method of claim 11, wherein the products used in the wellsite procedures comprise one or more of a drill bit used to drill a section of the wellbore, a drill string used in the wellbore, and a sensor configured to determine a downhole pressure of the wellbore.

18. The method of claim 11, further comprising: monitoring a real-time progress of the wellsite procedures with the drilling operations module of the supply chain twin platform.

19. The method of claim 11, wherein the materials module further comprises substitute data specifying components from a second supplier that are interchangeable with the parts from the first supplier.

20. The method of claim 19, further comprising: determining a difference in price between a previous cost of the parts and a current cost of the parts.
